(19) United States
(12) Patent Application Publication
(10) Pub. No.: US 2010/0245713 A1
(43) Pub. Date: Sep. 30, 2010

(54) LIGHT SOURCE DEVICE, BACKLIGHT DEVICE, AND LIQUID CRYSTAL DISPLAY

(76) Inventors: Tadashi Yano, Kyoto (JP); Kazuaki Ohkubo, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/159,510

(22) PCT Filed: Oct. 23, 2007
(86) PCT No.: PCT/JP2007/070626

§ 371 Date: Jun. 27, 2008

(30) Foreign Application Priority Data
Oct. 26, 2006 (JP) 2006-290926

(51) Int. Cl. G02F 1/1335; F21S 4/00; G02F 1/13357

(52) U.S. Cl. 349/64; 362/225; 362/97.1

(57) ABSTRACT

A light source device 11 includes a plurality of tube-shaped light sources 17 arranged with an interval provided therebetween, so that an axis line L extends in the same direction; and a reflection plate 18 disposed on the backside of each light source 17 viewed from a light extracting direction. The reflection plate 18 includes a flat portion 28 opposed to the light source 17 and a concave shaped portion 27 recessed from the flat portion 28 in a direction spaced from the light source 17, with an opening edge 29 formed in a circular shape or an oval shape. A plurality of concave shaped portions 27 are arranged along at least the axis line L of the light source viewed from the light extracting direction. Light distribution characteristics not dependent on an arrangement direction of the light sources 17 can be obtained.

### TECHNICAL FIELD

The present invention relates to a light source device suitable for a backlight device of a liquid crystal display.

### BACKGROUND ART

In recent years, technical developments for achieving a thinner display are activated, and a new system of display called a flat display panel (FDP) is widely commercialized to replace a cathode-ray tube. A liquid crystal display is one of most prevailing systems of the FDPs. The liquid crystal display consists of a planar light source device called a liquid crystal panel and a backlight device. By electrically opening/closing a window of each pixel formed by a liquid crystal element of the liquid crystal panel, lights from the backlight device are transmitted selectively by the window of each pixel. These transmitted lights display pictures and characters on a panel surface.

A recent development trend of the liquid crystal display requires larger size and higher brightness. For satisfying such requirements, a system called a “direct type” can be adopted as the backlight device. The direct type light source device generally includes parallely arranged several long tube-shaped light sources, diffusion plates arranged above these light sources for improving a luminance uniformity and a focusing property, optical sheets such as a diffusion sheet and a lens sheet, and a reflection plate for reflecting lights from light sources toward the optical sheets.

In the direct type light source device, areas directly above the light sources show high-brightness whereas areas between the light between the light sources show low-brightness, thereby causing a tendency where a striped pattern due to a difference in brightness is generated. Therefore, an important subject in the direct type light source device is to constitute an optical system in which the light sources arranged in parallel can emit lights as a surface of uniform luminance (surface having high luminance uniformity).

Conventional direct type light source devices include one having a reflection plate designed to increase quantity of light between light sources for improving luminance uniformity. For example, Patent Publication 1 discloses a light source device having such reflection plate.

FIG. 20 is a sectional view of the light source device disclosed in Patent Publication 1. In FIG. 20, a light source 1 is a long fluorescent tube which is usually a cold cathode fluorescent lamp. A flat reflection surface 2 is a reflection plate of low reflectivity. Triangular protrusions 3 are the reflection plates of high reflectivity and manufactured separately from the flat reflection surface 2. The triangular protrusions 3 are disposed at a positions corresponding to intervals 4 between the light sources above the flat reflection surface 2 so as to extend along a longitudinal direction of the light source 1. Light beams 5 emitted from light sources 1 and reflected by the triangular protrusion 3 are guided to the intervals 4 between the light sources 1, thereby increasing quantity of light to achieve improvement of the luminous uniformity. Similarly to the Patent Publication 1, Patent Publication 2 also discloses the reflection plate having protrusions disposed at the positions corresponding to the interval between the light sources on the reflection plate so as to extend along a longitudinal direction of the light source.

However, the arrangement where the triangular protrusions 3 are disposed between the light sources 1 so as to extend along the longitudinal direction as shown in FIG. 20 largely affect angular characteristics of irradiation from the light source 1. This will be described herebelow.

When the direct type light source device is used as the backlight device of the liquid crystal display, tube-shaped light sources are normally arranged in a posture where tube axes or axis lines extend in a horizontal direction when a gravity direction is set as an vertical direction. In a case of the light source device of FIG. 20, the triangular protrusions are also arranged so as to extend in the horizontal direction corresponding to the posture of the light source 1. In this arrangement, a vertically reflected light is intercepted by the triangular protrusions 3, and therefore quantity of the vertically reflected light is smaller than that of a horizontally reflected light. This results in that the liquid crystal display has a wide horizontal view angle and a narrower vertical view angle (a depression angle and an elevation angle) than the horizontal view angle due to interruption by the triangular protrusions 3. However, since viewing the liquid crystal display from the vertical direction is rare during practical usage, the narrow vertical view angle is not practically problematic.

A mercury free fluorescent lamp using a rare gas such as xenon as a main discharge medium is known. The mercury free fluorescent lamp is preferable from a viewpoint of an environmental protection because of not using mercury, and has an advantage that the luminance is hardly influenced by a surrounding temperature. The shorter the length of the mercury free fluorescent lamp is, the higher an efficiency of the mercury free fluorescent lamp is. Therefore, when used as the light source in the backlight device for the liquid crystal display of a large screen, the mercury fluorescent free lamps are preferably arranged in a posture where the tube axis extends in the vertical direction. However, in the structure of FIG. 20, when a plurality of light sources 1 are arranged in parallel in a posture where the tube axis extends in the vertical direction, the triangular protrusions are also arranged so as to extend in the vertical direction. In this arrangement, the horizontally reflected light is intercepted by the triangular protrusion 3, and therefore the quantity of the horizontally reflected light becomes smaller than that of the vertically reflected light. This results in that the liquid crystal display has limited and narrowed horizontal view angle due to the interruption of triangulars 3. Since viewing the liquid crystal display from the horizontal direction is quite ordinary, the narrow view angle in the horizontal direction is problematic in practical use.

As discussed above, in the arrangement of FIG. 20, the angular characteristics of irradiation are changed according to the posture or an arrangement direction of the light sources, thereby largely affecting the view angular characteristics when the light source device is used as the backlight device of the liquid crystal display.

In addition to the direct type, a system called an edge light type is known as the light source device used for the backlight device. In the edge light type light source device, the light beam from the light source is guided into a light guide plate from an end face and then emitted from an entire surface of the light guide plate by total reflection. Patent Publication 3 discloses the edge light type light source device having the reflection plate intended for improvement of luminance uniformity. However, relative arrangement of the light source and the reflection plate is completely different between the edge light type and the direct type. Therefore, disclosures of the Patent Publication 3 include no suggestion regarding a solution for dependency of the angular characteristic of irradiation on the arrangement direction of the light sources.

Patent Publication 1: Japanese Patent Application Laid-open Publication No. 05-2165 (FIG. 2)

Patent Publication 2: Japanese Patent Application Laid-open Publication No. 2005-150037 (FIG. 1)

Patent Publication 3: Japanese Patent Application Laid-open Publication No. 2004-179116 (FIG. 2)

### DISCLOSURE OF THE INVENTION

### Problem to be Solved by the Invention

An object of the present invention is to provide a light source device having luminous intensity characteristics not dependent on a distribution direction of a light source, while securing uniformity of a luminance distribution, i.e., luminance uniformity.

### Means for Solving the Problem

A first aspect of the present invention provides a light source device comprising a plurality of tube-shaped light sources arranged at intervals so that axis lines thereof extend along the same direction, and a reflection member arranged to backsides of the light sources viewed from a light extracting direction and having a flat portion opposed to the light sources and a plurality of concave shaped portions recessed from the flat portion in a direction away from the light sources, the concave shaped portions having circular or elliptical opening edges formed at connection portions with the flat portion and being arranged at least along each of the axis lines of the light sources viewed from the light extracting direction.

The reflection member is arranged, with a plurality of concave shaped portions arranged along the axis line of the individual light source viewed from the light extracting direction.

The reflection member having the plurality of concave shaped portions respectively arranged along the axis line of each of the light sources viewed from the light extracting direction. This achieves a luminous intensity distribution not dependent on a posture or an arrangement direction of the light source, namely, whether the light source is arranged in a vertical direction or in a horizontal direction.

It is preferable that a radius of the circular shape or a long axis of the elliptical shape constituting the opening edge is larger than an outer radius of the light source.

By setting the radius or the long axis of the opening edge of each concave shaped portion to be larger than the outer radius of the light source, the light quantity that can be extracted from the light source device can be increased.

The concave shaped portion has, for example, a conical surface or parabolic surface. The parabolic surface in this specification includes both of a narrowly-defined parabolic surface, namely, a rotary parabolic surface obtained by rotating the parabolic curve about an axis of symmetry, and a broadly-defined parabolic surface obtained by changing an aspect ratio of the rotary parabolic surface.

It is preferable that the axis line of each of the light sources and a center line formed by connecting positions spaced furthest from the axis line of the plurality of concave shaped portions arranged along the axis line substantially coincide with each other viewed from the light extracting direction

Such setting of a positional relation between the light source and the concave shaped portion also increases the light quantity that can be extracted from the light source device.

It is preferable that the concave shaped portions are arranged at the flat portion between the light sources adjacent to each other viewed from the light extracting direction.

This structure improves the luminance uniformity.

It is preferable that a depth of each of the concave shaped portions arranged between the light sources is deeper than the depth of each of the concave shaped portions arranged along the axis lines of the light sources.

When the depth of the concave shaped portion is shallow, the luminous intensity distribution is widened. When the depth of the concave shaped portion is deep, the luminous intensity distribution having a large light quantity in the light extracting direction is obtained. By setting the depth of the concave shaped portions between the light sources to be deeper than that of the concave shaped portions arranged along the light axis of the light source, the light quantity between the light sources can be increased, thus enabling further improvement of the luminance uniformity.

When the light sources are arranged in a posture where the axis line extends in a gravity direction, it is preferable that the opening edges of the concave shaped portions arranged along the axis lines of the light sources have the optical shape with a short axis extending along the axis line viewed from the light extracting direction

Such shaped concave shaped portions narrow the luminous intensity distribution in the vertical direction and widen the luminous intensity distribution in the horizontal direction.

A second aspect of the present invention provides a backlight device comprising, the above-mentioned light source device, an optical member including at least a diffusion plate having a light incident surface and a light outgoing surface and guiding lights emitted from the light source device from the light incident surface to the light outgoing surface so as to emit the lights from the light outgoing surface.

A third aspect of the present invention provides a liquid crystal display comprising the above-mentioned backlight device and a liquid crystal panel disposed so as to be opposed to the light outgoing surface of the diffusion plate.

### EFFECT OF THE INVENTION

The light source device of the present invention is suitable for being used in the backlight device of the liquid crystal display. When the present invention is applied to the backlight device of the liquid crystal display, the visual angular characteristics not dependent on the arrangement direction of the light source can be obtained.

### EFFECT OF THE INVENTION

The light source device of the present invention includes the reflection plate having a plurality of concave shaped portions arranged respectively in the individual light source along the axis line viewed from the light extracting direction.

Because having the reflection member formed with the plurality of concave shaped portions respectively arranged along the respective axis lines of the light sources viewed from the light extracting direction, the light source device of the present invention achieves the luminous intensity distribution characteristics not dependent on the arrangement direction of the light sources. This realizes the light source device where the light quantity does not largely depend on a direction viewed by a user. Further, by arranging the concave shaped portions between light sources, the luminance uniformity can be improved. Accordingly, by applying the light source device of the present invention to the backlight device of the liquid crystal display, the visual angular characteristics not dependent on the arrangement direction of the light sources can be obtained with securing the high luminance uniformity.

### BRIEF DESCRIPTION OF THE DRAWINGS

FIG. 1 is a sectional view of a liquid crystal display including a light source device according to a first embodiment of the present invention;

FIG. 2 is an exploded perspective view of the liquid crystal display including the light source device according to the first embodiment of the present invention;

FIG. 3 is a schematic view showing a wiring structure of the light source device (internal-external electrode type) according to the first embodiment of the present invention;

FIG. 4A is a partial schematic perspective view of a reflection plate in the first embodiment;

FIG. 4B is a schematic front view of the reflection plate (xy surface) in the first embodiment;

FIG. 4C is a sectional view taken along a line IV-IV (xz section) of FIG. 4B;

FIG. 4D is a sectional view taken along a line IV′-IV′ (yz section) of FIG. 4B;

FIG. 5 is a luminous intensity distribution view of the light source device according to the first embodiment of the present invention obtained by optical simulations;

FIG. 6 is a graph showing a relation between a ratio of an outer radius of a light source to a radius of an opening edge of a concave shaped portion and a luminance in the light source device according to the first embodiment;

FIG. 7 is a sectional view of a liquid crystal display including the light source device according to a second embodiment of the present invention;

FIG. 8A is a schematic partial perspective view of a reflection plate in the second embodiment;

FIG. 8B is a schematic front view of the reflection plate (xy surface) in the second embodiment;

FIG. 8C is a sectional view taken along a line XIII-XIII (xz section) of FIG. 8B;

FIG. 8D is a sectional view taken along a line XIII′-XIII′ (yx section) of FIG. 8B;

FIG. 9 is a graph showing a relation between a position for a recess portion of a tube axis and a luminance in the light source device according to the second embodiment of the present invention;

FIG. 10 is a sectional view of a liquid crystal display including a light source device according to a third embodiment of the present invention;

FIG. 11A is a schematic partial perspective view of a reflection plate in the third embodiment;

FIG. 11B is a schematic front view of the reflection plate (xy surface) in the third embodiment;

FIG. 11C is a sectional view taken along a XI-XI line (xz section) of FIG. 11B;

FIG. 11D is a sectional view taken along a line XI′-XI′ (yz section) of FIG. 11B;

FIG. 12A is a schematic partial perspective view of a reflection plate disposed in a light source device according to a fourth embodiment of the present invention;

FIG. 12B is a schematic front view of the reflection plate (xy surface) in the fourth embodiment;

FIG. 12C is a sectional view taken along a line XII-XII (xz section) of FIG. 12B;

FIG. 12D is a sectional view taken along a line XII′-XII′ (yz section) of FIG. 12B;

FIG. 13A is a schematic partial perspective view of a reflection plate disposed in a light source device according to a fifth embodiment of the present invention;

FIG. 13B is a schematic front view of the reflection plate (xy surface) in the fifth embodiment;

FIG. 13C is a sectional view taken along a line XIII-XIII (xz section) of FIG. 13B;

FIG. 13D is a sectional view taken along a line XIII′-XIII′ (yz section) of FIG. 13B;

FIG. 13E is a sectional view taken along a line XIII″-XIII″ (yz section) of FIG. 13B;

FIG. 14A is a schematic partial perspective view of a reflection plate disposed in a light source device according to a sixth embodiment of the present invention;

FIG. 14B is a schematic front view of the reflection plate (xy surface) in the sixth embodiment;

FIG. 14C is a sectional view taken along a line XIV-XIV (xz section) of FIG. 14B;

FIG. 14D is a sectional view taken along a line XIV′-XIV′ (yz section) of FIG. 14B;

FIG. 14E is a sectional view taken along a line XIV″-XIV″ (yz section) of FIG. 14B;

FIG. 15A is a schematic partial perspective view of a reflection plate disposed in a light source device according to a seventh embodiment of the present invention;

FIG. 15B is a schematic front view of the reflection plate (xy surface) in the seventh embodiment;

FIG. 15C is a sectional view taken along a line XV-XV (xz section) of FIG. 15B;

FIG. 15D is a sectional view taken along a line XV′-XV′ (yz section) of FIG. 15B;

FIG. 15E is a sectional view taken along a line XV″-XV″ (yz section) of FIG. 15B;

FIG. 16 is a schematic view showing a design concept of the shape of the concave portion in the seventh embodiment;

FIG. 17 is a schematic view showing a first alternative of a wiring structure (internal-external electrode type);

FIG. 18 is a schematic view showing a second alternative of the wiring structure (internal-internal electrode type);

FIG. 19 is a schematic view showing a third alternative of the wiring structure (external-external electrode type);

FIG. 20 is a partial schematic view showing a conventional light source device.

### DESCRIPTION OF REFERENCE NUMERALS

11: Light source device
12: Backlight device
13: Liquid crystal panel
14: Liquid crystal display
15: Casing
17: Light source
18: Reflection plate
19: Diffusion plate
19a: Light incident surface
19b: Light outgoing surface
20: Diffusion sheet
21: Lens sheet
22: Luminance increasing film
23: Bulb
24: Internal electrode
25: Lighting circuit
27: Concave shaped portion
28: Flat portion
29: Opening edge
30: External electrode
L: Axis line
I: Outer radius of bulb
r: Radius of opening edge
P: Point
C: Center line
C′: Center line

### BEST MODE FOR CARRYING OUT THE INVENTION

Preferred embodiments of the present invention will be explained with reference to the drawings. In the attached drawing, a Z-direction indicates a light extracting direction, a y-direction indicates a vertical direction as a gravity direction, and an x-direction indicates a lateral direction as a horizontal direction.

### First Embodiment

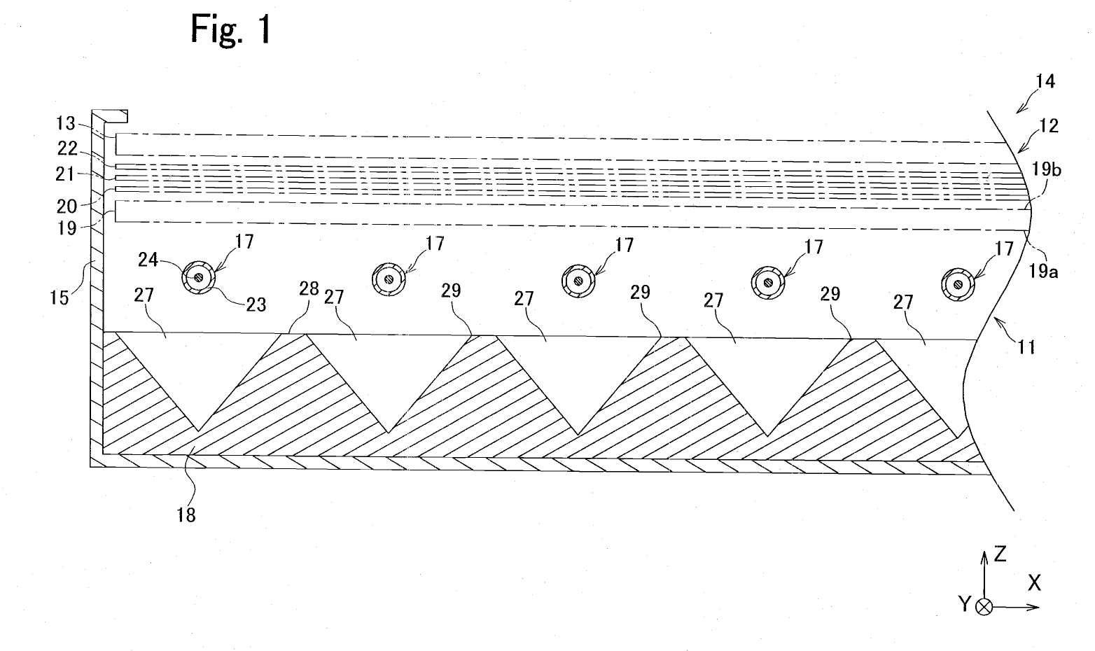

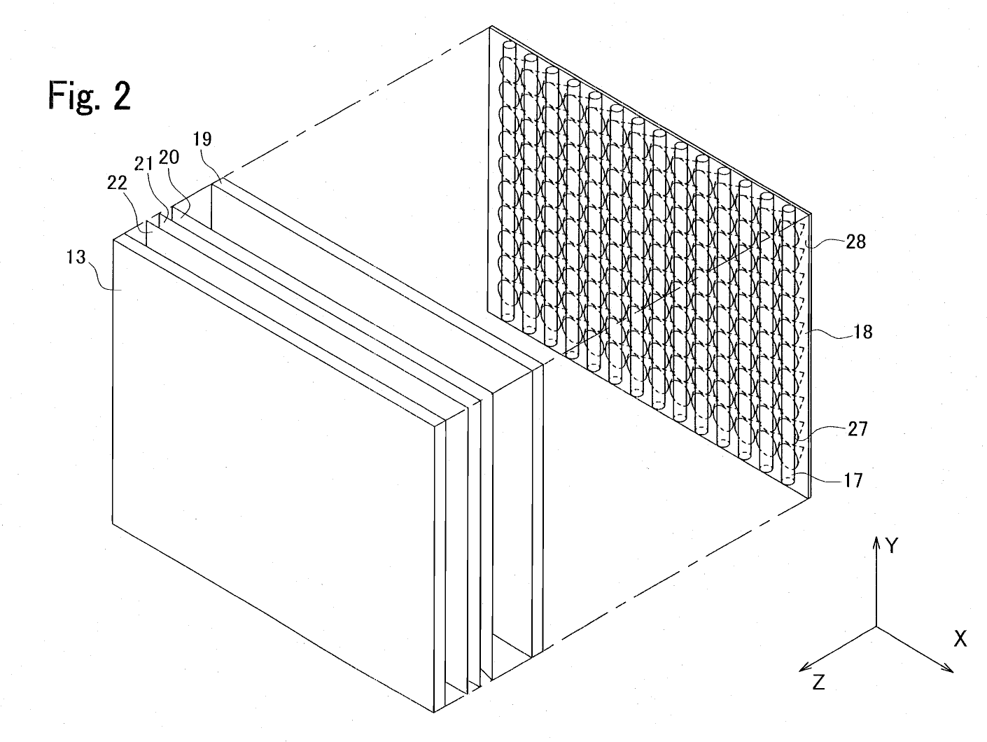

FIGS. 1 and 2 show a liquid crystal display 14 including a backlight device 12, which has a light source device 11 according to a first embodiment of the present invention, and a liquid crystal panel 13. In this embodiment, the backlight device 12 and the liquid crystal panel 13 are accommodated in a flattened rectangular shaped casing 15. The light source device 11 includes a plurality of light sources 17 and a reflection plate (reflection member) 18. In addition to the light source device 11, the backlight device 12 includes a diffusion plate 19, a diffusion sheet 20, a lens sheet 21, and a luminance increasing film (DBFE) 22, each of which is an optical sheet (optical member). The optical sheets 19 to 22 are common in all embodiments, and therefore will be described in detail later.

The light source 17 is a long tube-shaped fluorescent tube. In this embodiment, a xenon fluorescent lamp of an internal-external electrode type is used as the light source 17. However, a cold cathode low-pressure mercury fluorescent lamp can also be used. The light source 17 includes a bulb 23 enclosing a discharge medium containing xenon and an internal electrode 24 disposed inside of the bulb 23 at one of end portions. As will be described in detail later, the reflection plate 18 also functions as an external electrode.

It is practical that an outer diameter “I” of a fluorescent tube or the bulb 23 of the light source 17 is between 3 mm and 5 mm. In this embodiment, the bulb 23 with the outer diameter of 3 mm (1.5 mm of outer radius) is used. In addition, it is practical that a longitudinal dimension (length) of the bulb 23 is between 100 mm and 1000 mm depending on a size of a display. In this embodiment, the length of the bulb 23 is 710 mm.

In this embodiment, the liquid crystal display 14 is 32 inch size. Thirty-two light sources 17 are arranged in a posture where a tube axis or an axis line “L” extends in the vertical direction as the gravity direction, or in up-and-down direction (y-direction). The light sources 17 are arranged at equal intervals (interval of 15.6 mm) of the horizontal direction or the lateral direction (X direction). In other words, thirty-two light sources 17 are arranged at equal intervals on a flat surface parallel to an XY flat surface and extending in the vertical direction. The above-mentioned length of the bulb 23 (710 mm) is set so as to correspond to the 32 inch size liquid crystal display when the light sources 17 are arranged with the axis line “L” extending in the vertical direction.

The reflection plate 18 is disposed to backside of the light source 17 viewed from the light extracting direction. A reflectivity of a reflection surface of the reflection plate 18 is 98%, and the reflection plate 18 has a high secularity.

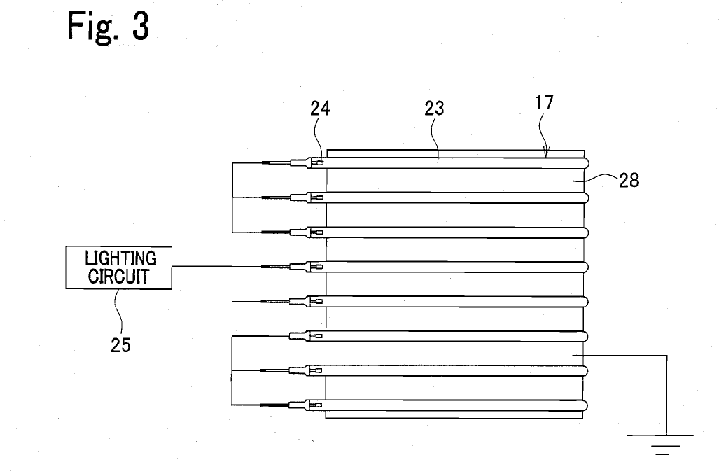

With reference to FIG. 3, the reflection plate 18 also serves as the external electrode of the fluorescent lamp of internal-external electrode type. Discharge of the discharge medium inside the bulb 23 is a dielectric barrier discharge. Therefore, there is no necessity for disposing lighting circuits 25 for every light source 17, and all light sources 17 can be lighted by at least one lighting circuit 25. In the internal-external electrode type fluorescent lamp, the external electrode is preferably spaced from the discharge medium enclosed inside the bulb, and may be in contact with the bulb 23. However, in this embodiment, an interval is provided between the bulb 23 and the reflection plate 18 as the external electrode, and a minimum distance between them is set at 3.1 mm which achieves the highest system efficiency.

The reflection surface of the reflection plate 18 is not merely a flat surface, but is formed with a plurality of dimples or concave shaped portions 27. Specifically, the reflection plate 18 has a flat portion 28 which is opposed to the light sources 17 and parallel to the XY flat surface. Formed on the flat portion 28 are a plurality of concave shaped portions 27 having the same shape and recessed in a direction away from the light source 17 (−Z direction).

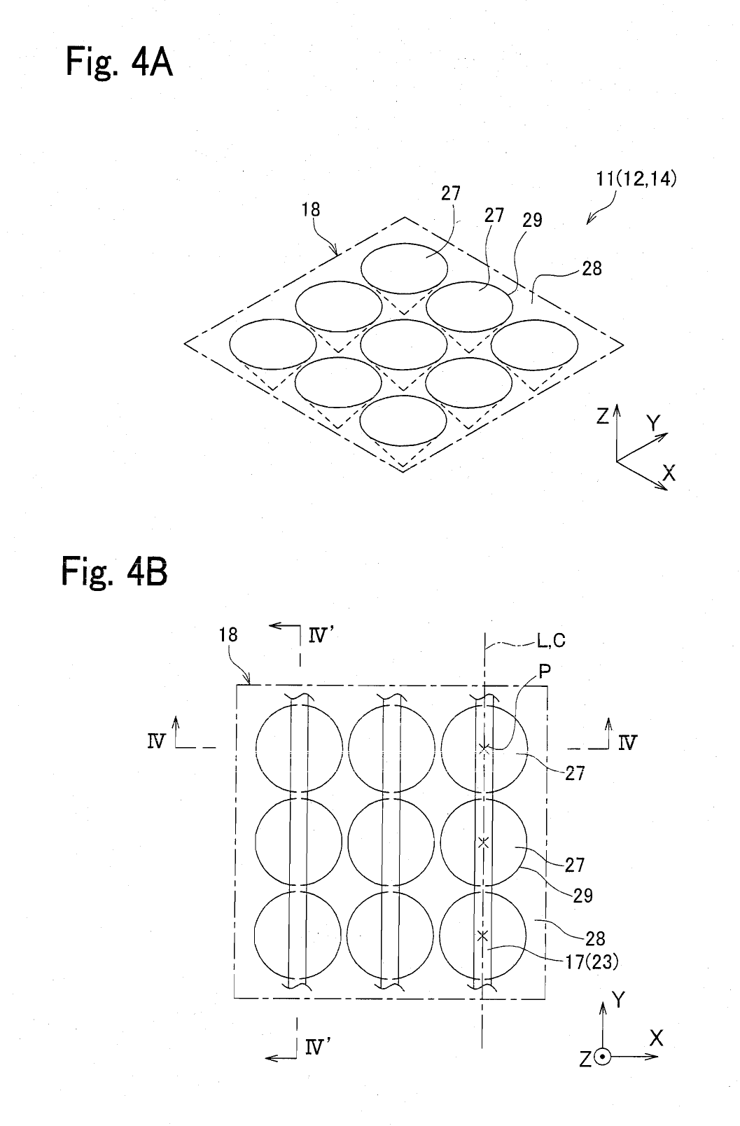

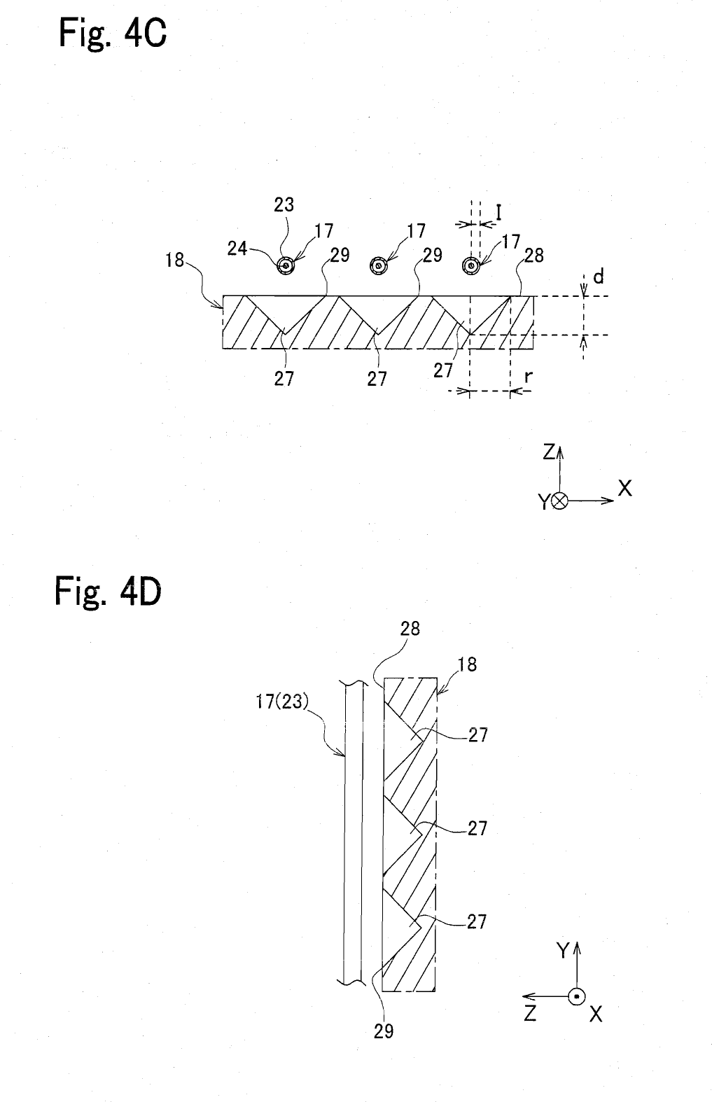

FIGS. 4A to 4D show details of the reflection plate 18 having the plurality of concave shaped portions 27. FIG. 4A is a perspective view, FIG. 4B shows the XY flat surface, FIG. 4C shows a section parallel to the XZ flat surface, and FIG. 4D shows a section parallel to the YZ flat surface. For ease in understanding of shape of the concave shaped portion 27, FIGS. 4A to 4D show only a part of the reflection plate 18 so that 3×3, i.e., nine in total of concave shaped portions 27 are shown. As shown most clearly shown in FIG. 4A, the concave shaped portion 27 in this embodiment has a conical surface. In addition, an opening edge 29 formed at a connection portion between the concave shaped portion 27 and the flat portion 28 has a circular shape which is one of closed curves.

In this embodiment, the circular shape constituted by the opening edge 29 of the concave shaped portion 27 has a diameter of 15.6 mm (radius r of 7.8 mm). Accordingly, the circular shape constituted by the opening edge 29 of the concave shaped portion 27 is larger than the outer diameter of the bulb 23 (outer diameter is 3 mm, and outer radius “I” is 1.5 mm). Moreover, in this embodiment, a depth “d” of the concave shaped portion 27 (height of a cone) is 1.95 mm. As shown in FIG. 4B, the concave shaped portions 27 are arranged along the axis line “L” of the individual light source 17 viewed from a light extracting direction (2-direction). Specifically, for each of the light sources 17, the axis line “L” and a center line “C” formed by connecting points spaced furthest from the flat portion 28 in respective concave shaped portions 27 (tops of the conics in this embodiment) arranged along the axis line “L” coincide with each other viewed from the light extracting direction.

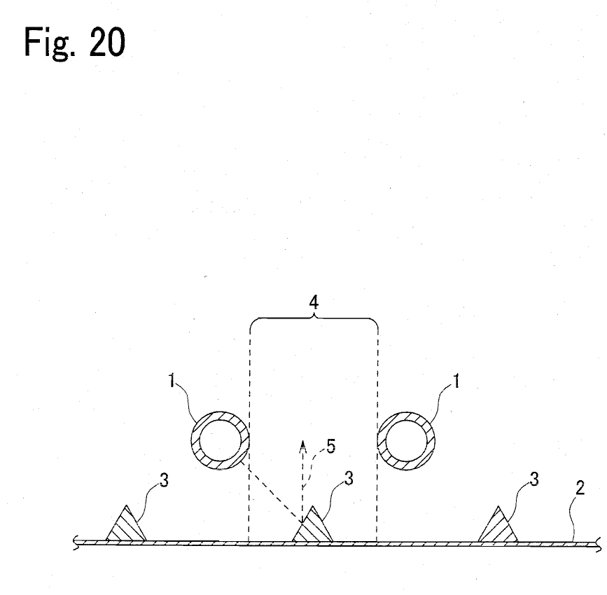

The reflection plate 18 can be integrally formed, because it is made of a uniform material. Accordingly, there is no necessity for preparing individually different reflection plates, unlike the conventional art shown in FIG. 20. In addition, there is no necessity for separately arranging the reflection plate and the triangular protrusions, unlike the conventional art shown in FIG. 20. Accordingly, the reflection plate 18 of this embodiment can be manufactured at a low cost.

A manufacturing method of the reflection plate 18 includes a method of applying pressing and cutting work to an aluminum flat plate, or a method of molding by a mold using a resin material followed by formation of a metal film by plating by aluminum or silver, sputtering, or deposition. In this embodiment, the reflection plate 18 is manufactured by pressing the aluminum flat plate.

Characteristics of the light source device 11 of this embodiment thus constituted will be explained.

First, since the plurality of concave shaped portions 27 on the reflection plate 18 are arranged along the axis line “L” of each of the light sources 17 viewed from the light extracting direction, it is possible to obtain luminous intensity distribution characteristics not dependent on the posture or the arrangement direction of the light sources 17, namely, not dependent on whether the light source 17 is arranged in the vertical direction or in the horizontal direction. Particularly, as is clear from FIG. 4C and FIG. 4D, the reflection plate 18 formed with the concave shaped portions 27, which are conical surfaces, has the same sectional shape on the xz surface and the yz surface. Accordingly, even when the light source 17 is arranged in the vertical direction or arranged in the horizontal direction, lights emitted from the light sources 17 have the same reflection characteristics in the concave shaped portions 27. In this point, the light source device 11 of this embodiment has a small restriction by the arrangement direction of the light sources, compared to the conventional art shown in FIG. 21 wherein the triangular protrusions extending in the longitudinal direction of the light sources are arranged on the reflection plate shown.

In addition, as is clarified from FIG. 4A to FIG. 4D, the individual concave shaped portions 27 formed on the reflection plate 18 are mutually separated from each other. Therefore, regarding the manufacture of the reflection plate 18, there is no restriction resulting from the size of the liquid crystal display 14. That is, in the structure of FIG. 20, the length of the triangular needs to be adjusted according to the length of the light sources. Meanwhile, in this embodiment, by cutting-out the reflection plate 18 already formed with the concave shaped portions 27 in a dimension according to the length of the light source 17, or by forming the concave shaped portions 27 on the reflection plate 18 cut-out according to the length of the light source 17, the size of the reflection plate 18 can be easily adjusted according to the size of the liquid crystal display 14.

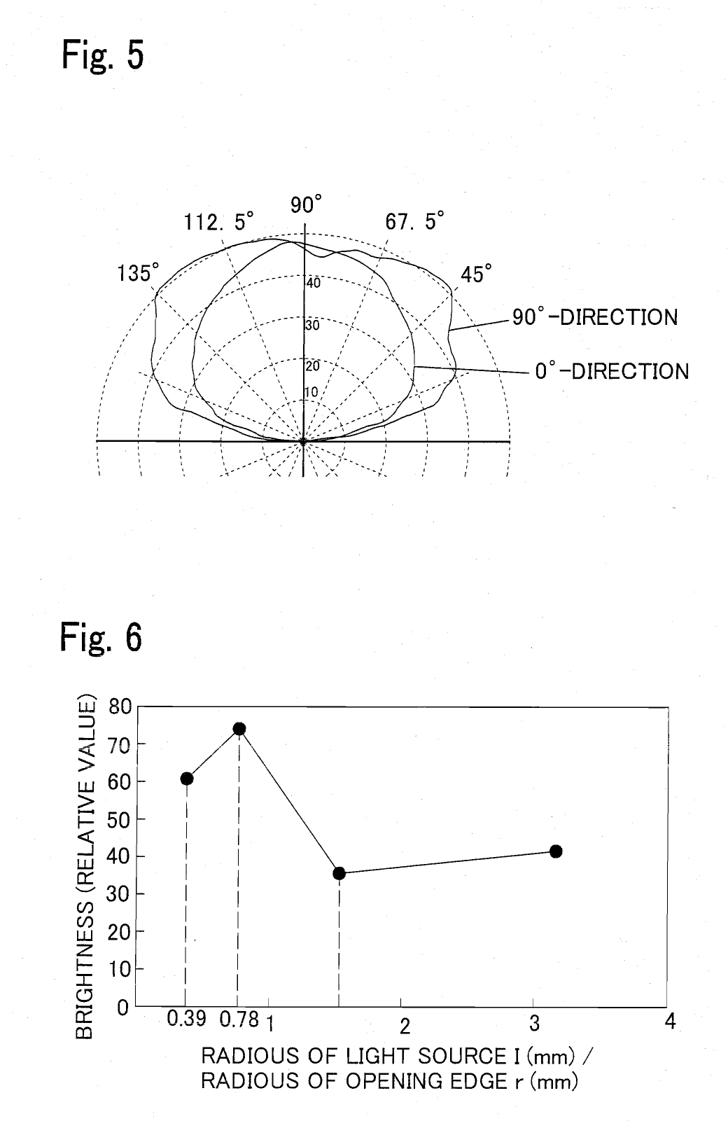

FIG. 5 shows a calculation result using optical simulations of characteristics of the light source device 11 of this embodiment. In this calculation, the number of light sources 17 was set to be 5. Further, the calculation was executed under a condition where the optical sheets 19 to 22 were removed from the liquid crystal panel 13 and directional cosines of lights entering a photometer disposed at a position infinitely spaced from the light source device 11 was calculated as brightness. Furthermore, the angular characteristics of 0°-direction (yz surface) and 90°-direction (xz surface) are calculated.

As is clear from FIG. 5, although there is a slight difference in an intensity of the brightness in both the directions of 0° and 90°, approximately circular shaped light distributions are obtained. Meanwhile, when the triangular protrusions are formed in the longitudinal direction of the light source as shown in FIG. 20, the angular characteristics in the 0°-direction are largely dependent on a surface shape extending in the longitudinal direction of the light source, thus forming a circular shaped light distribution. However, in the angular characteristics in the 90°-direction, generally a heart-like shaped light distribution shape is formed by increased brightness in 45° to 67.5° and 112.5° to 135° due to reflection of the triangular protrusions.

For the reasons discussed above, the light source device 11 of this embodiment with the light distribution formed in approximately a circular shape in the 0°-direction and in the 90°-direction achieves to realize a uniform light distribution with extremely small difference in the vertical direction and in the horizontal direction compared to the light source device having the triangle protrusions. The liquid crystal display 14 of this embodiment using such a light source device 11 in the backlight device 12 is capable of realizing visual angular characteristics not dependent on the direction viewed by the user, namely, not dependent on whether the user views from the horizontal direction or from the vertical direction.

Further, since the light distributions in the 0°-direction and in the 90°-direction are formed in approximately the circular shape as described above, it is continued that the light source device 11 of this embodiment has the light distribution characteristics not dependent on the direction of the light source 17, namely not dependent on whether the light source 17 extends in the vertical direction or in the horizontal direction.

FIG. 6 shows a calculation result using optical simulation of a relation between a ratio of the outer radius “I” of the light source 17 with respect to the radius “r” of the opening edge 29 of the conical concave shaped portion 27. In this FIG. 6, the abscissa axis shows a value (ratio) obtained by dividing the outer radius “I” (mm) of the light source 101 by the radius “r” (mm) of the opening edge 29 of a concave shaped portion 105. When this ratio “I/r” is smaller than 1, the outer radius “I” of the light source 17 is smaller than the radius “r” of the opening edge 29. The ordinate axis shows a relative value of the brightness outputted from the light source device. Other condition is the same as the calculation of the light distribution (FIG. 4).

From FIG. 6, it is found that when the brightness is increased when the radius “r” of the opening edge 29 of the concave shaped portion 27 is larger than the outer radius “I” of the light source 17. Namely, in order to extract much more light quantity from the light source device, it is preferable to set the radius of a bottom face of the concave shaped portion 105 larger than the radius of the light source 17.

As described above, in the light source device 11 of this embodiment, by arranging a plurality of light sources 17 above the reflection plate 18 in which the plurality of conical shaped concave shaped portions are formed, the light distribution not dependent on the arrangement direction of the light source 17 is achieved. In addition, by applying this light source device 11 to the backlight device 11, the liquid crystal display having the visual angular characteristics not largely dependent on the direction viewed by the user is achieved. Further, by making the radius “r” of the opening edge 29 of the concave shaped portion 27 having the conical shape larger than the outer radius “I” of the light source 17, the light quantity extracted from the light source device 11 can be improved.

### Second Embodiment

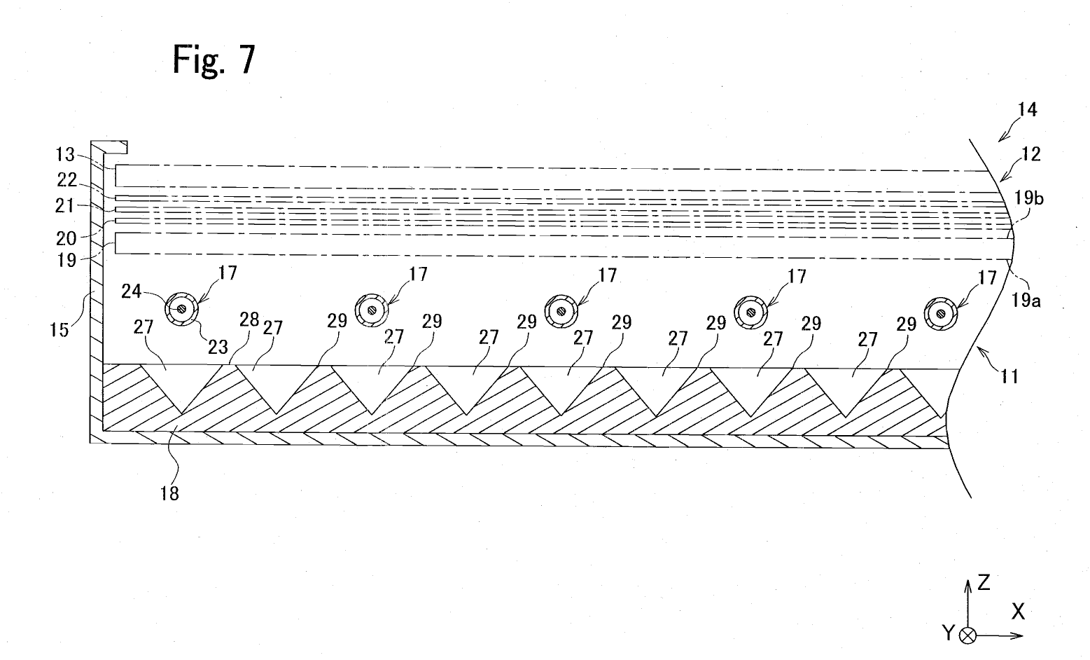

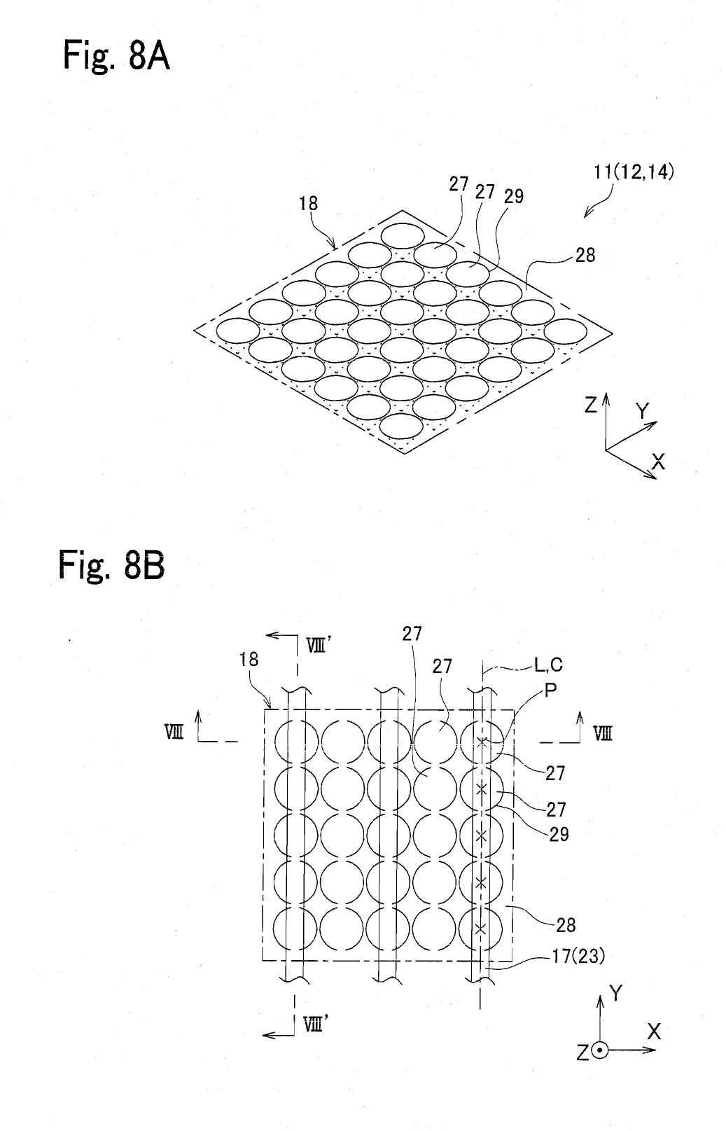

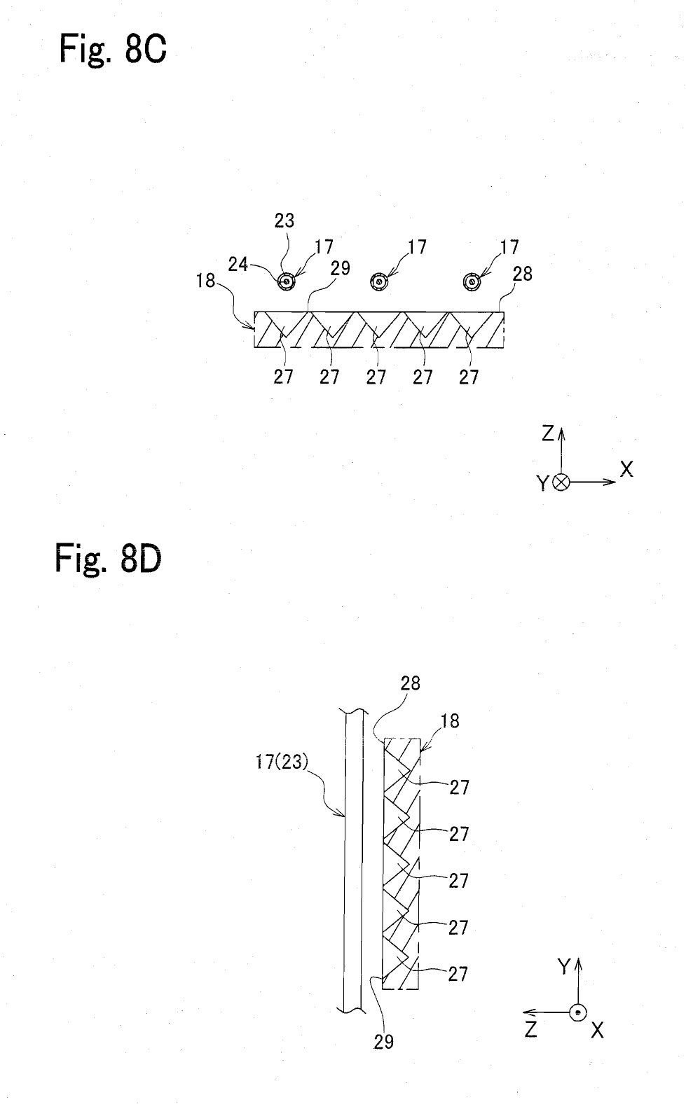

In a light source device 11 of a second embodiment of the present invention shown in FIG. 7 to FIG. 8D, a plurality of concave shaped portions 27 are arranged between mutually adjacent light sources 17 of a reflection plate 18 viewed from the light extracting direction. Specifically, in addition to that the light sources 17 are arranged along the axis line “L” of the individual light source 17 viewed from the light extracting direction, and also the concave shaped portions 27 of one row are arranged between the mutually adjacent light sources 17 at equal interval. In this embodiment, all the concave shaped portions 27 have the same shape.

Similarly to the first embodiment, the reflectivity of the reflection plate 18 is 98%. Further, similarly to the first embodiment, the concave shaped portion 27 has the shape of conical surface with a radius “r” of an opening edge 29 set at 3.9 mm and a depth “d” set at 0.975 mm. Furthermore, the light source 17 is the internal-external electrode type, including the internal electrode in a bulb 23, and the reflection plate 18 also serves as the external electrode. A minimum distance between the light source 17 and the reflection plate 18 is set at 3.1 mm which achieves highest system efficiency. The interval between the adjacent light sources 17 in the lateral direction (x-direction) is set at 15.6 mm. Other structures of the light source device 11 of this embodiment are the same as those of the first embodiment.

The light source device 11 of this embodiment achieves the light distribution not dependent on the arrangement direction of the light source 17 and the visual angular characteristics not largely dependent on the direction viewed by the user similarly to the first embodiment. In addition to theses, the light source device 11 of this embodiment achieves improvement the luminance uniformity by providing the concave shaped portions 27 between the adjacent light sources 17 of the reflection plate 18.

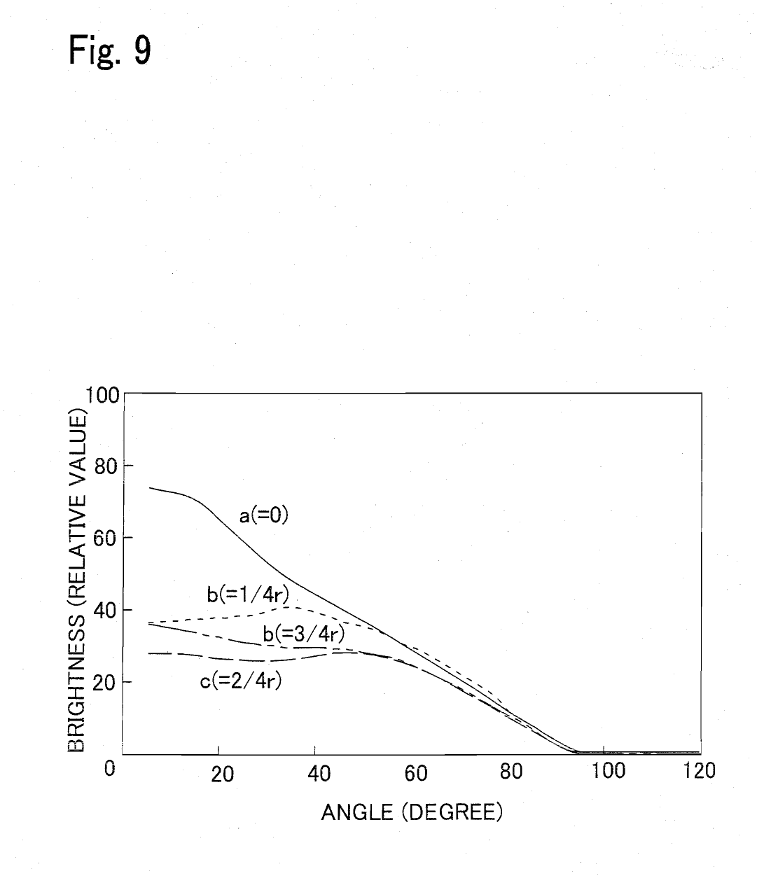

FIG. 9 shows calculation result using optical simulation of a relation between a relative position of the center line “C” formed by connecting deepest points “P” of the concave shaped portions 27 with respect to the axis line “L” of the light source 17 viewed from the light extracting direction and the angular characteristics of the brightness in the 0°-direction (yz direction). In this calculation, the relation of directionality of light, i.e., the angular characteristics of the brightness was obtained by using software for optical simulation (“Light Tools” by Cybernet Systems Co., Ltd.). Further, in this calculation, the number of light sources 17 is set to be five. Furthermore, the calculation was executed under a condition where the optical sheets 19 to 22 were removed from the liquid crystal panel 13 and directional cosines of lights entering a photometer disposed at a position infinitely spaced from the light source device 11 was calculated.

In FIG. 9, an angle component in the 0°-direction is taken on the abscissa axis, and a relative value of the brightness is taken on the ordinate axis. A reference sign “a” of FIG. 9 shows a case where the axis line “L” and the center line “C” coincide with each other viewed from the light extracting direction. A reference sign “b” shows a case where the concave shaped portions 27 are shifted rightward by “1/4r” (“r” is the radius of the opening edge 29 of the concave shaped portion 27) viewed from the light extracting direction. Namely, the reference sing “b” shows a case where the distance between the axis line “L” and the center line “C” is 0.975 mm viewed from the light extracting direction. A reference sing “c” shows a case where the concave shaped portions 27 are shifted rightward by “2/4r” viewed from the light extracting direction. Namely, the reference sign “c” shows a case where the distance between the axis line “L” and the center line “C” is 1.95 mm viewed from the light extracting direction. A reference sign “d” shows a case where the concave shaped portions 27 are shifted rightward by “2/4r” viewed from the light extracting direction. Namely, the reference sign “d” shows a case where the distance between the axis line “L” and the center line “C” is 2.85 mm viewed from the light extracting direction.

From FIG. 9, it is found that the brightness in the case of “a”, i.e., when the axis line “L” and the center line “C” coincide with each other viewed from the light extracting direction is higher than the brightness in the cases of “b”, and “d”. Particularly, when the axis line “L” and the center line “C” coincide with each other, the brightness in the vicinity of the angle 0° is extremely high.

As described above, by making the center line “C” of the concave shaped portions 27 formed on the reflection plate and the axis line “L” of the light source 17 coincide with each other, the light quantity extracted from the light source device 11 can be improved.

In this embodiment, one row of the concave shaped portions 27 are arranged between the mutually adjacent light sources 17. However, a plurality of rows of the concave shaped portions 27 may be arranged between the adjacent light sources 17. Other structures and operations of the second embodiment are the same as those of the first embodiment, and therefore the same reference signs are assigned to the same elements and explanations therefore are omitted.

### Third Embodiment

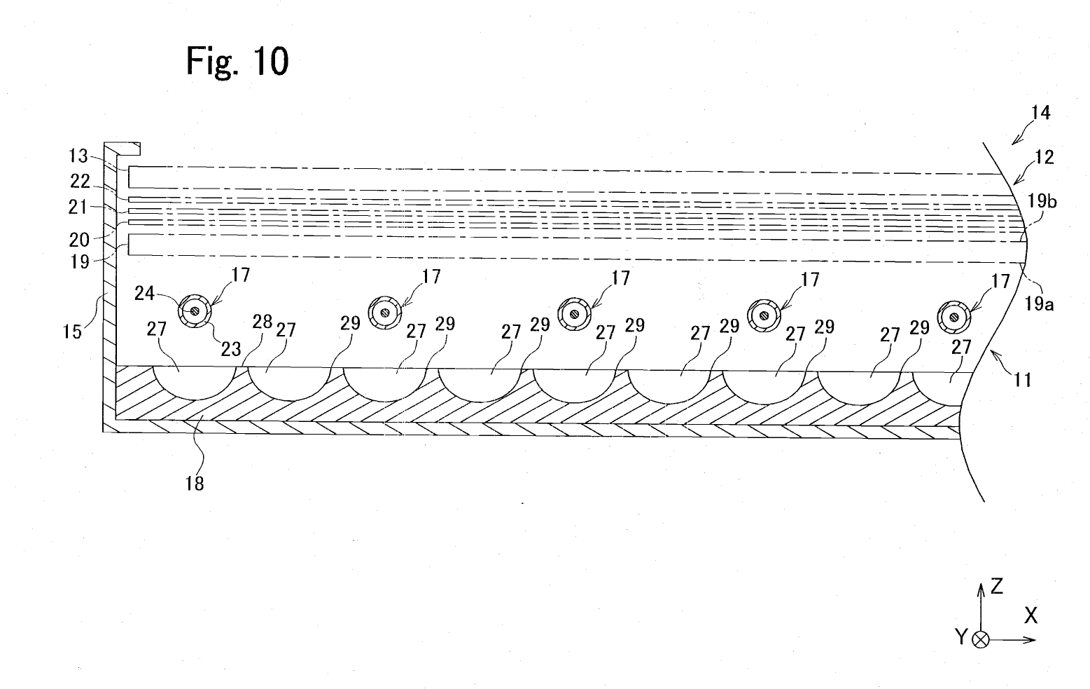

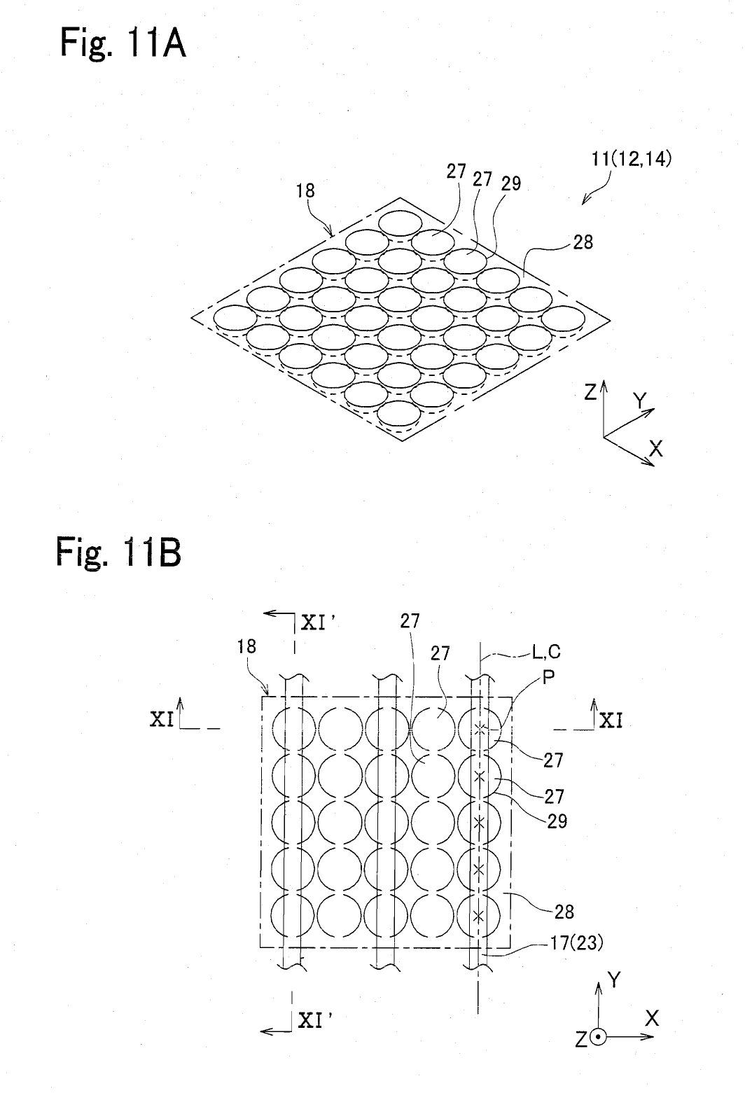

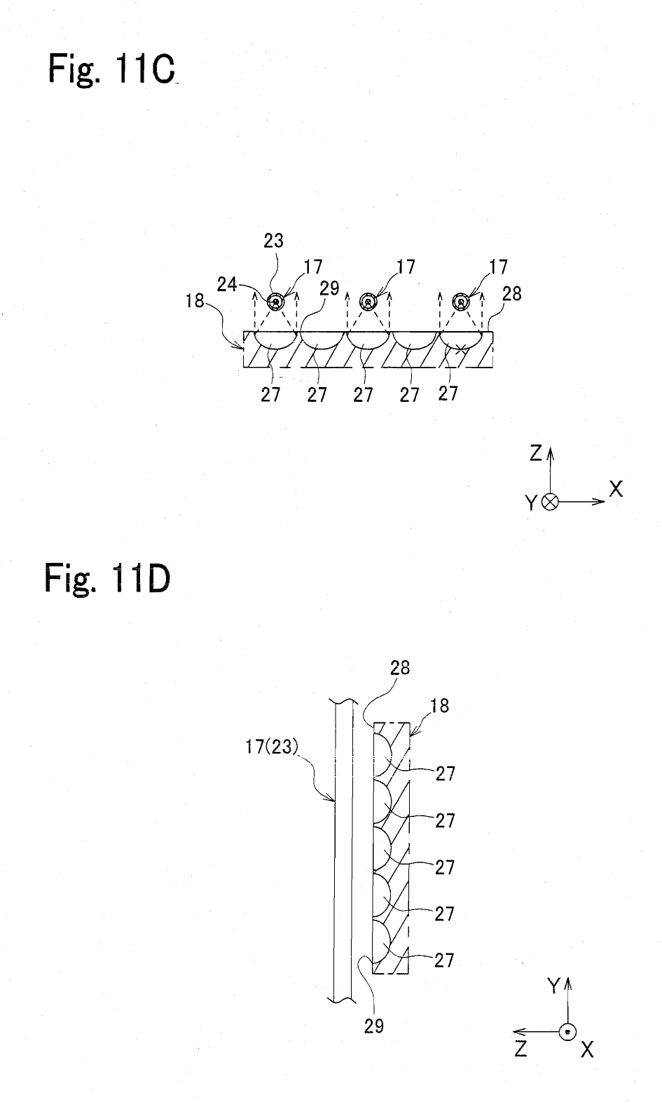

In a light source device 11 of a third embodiment of the present invention shown in FIG. 10 to FIG. 11D, in the same manner as the second embodiment, concave shaped portions 27 are arranged on a reflection plate 18 along an axis line “L” of an individual light source 17 viewed from the light extracting direction, and also concave shaped portions 27 are arranged between the mutually adjacent light sources 17. In this embodiment, all concave shaped portions 27 have the same shape.

The concave shaped portion 27 in this embodiment is formed in a rotary parabolic surface (a three-dimensional curved surface obtained by rotating a parabola about its symmetry axis), and an opening edge 29 is formed in a circular shape. A center line “C” formed by connecting points spaced furthest from a flat portion 28 of the concave shaped portions 27 (apexes of the rotary parabolic surfaces in this embodiment) “P” arranged along the individual light sources 17 coincides with the axis line “L” of the light source 17 viewed from the light extracting direction. Further, as shown in FIG. 11C, the axis line “L” of the light source 17 coincides with a focal point of the rotary parabolic surface constituted by the concave shaped portion 27. By such arrangement of the light sources 17 and the concave shaped portions 27, the light quantity of the light beam reflected by the concave shaped portions 27 and emitted to a front face is improved.

Other structures and operations of the third embodiment are the same as those of the second embodiment, and therefore the same reference signs are assigned to the same elements and explanations therefore are omitted.

### Fourth Embodiment

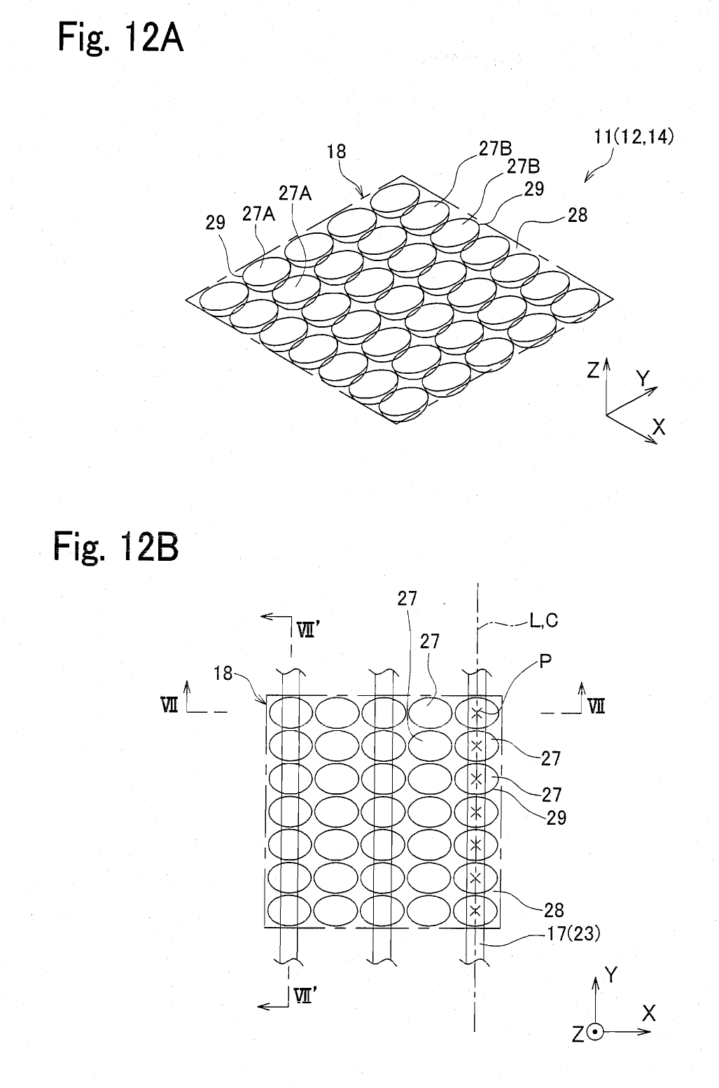

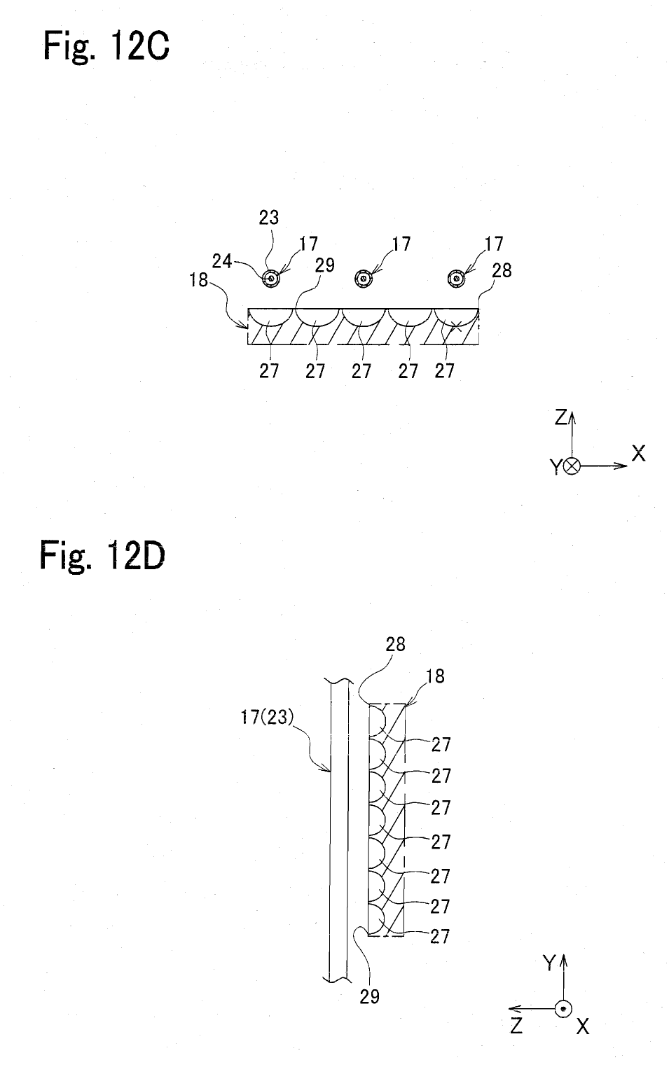

In a light source device 11 of a fourth embodiment of the present invention shown in FIG. 12A to FIG. 12D, a reflection plate 18 not only has concave shaped portions 27 arranged along the axis line “L” of a light source 17 viewed from the light extracting direction but also has the concave shaped portions 27 arranged between the mutually adjacent light sources 17 viewed form the light extracting direction in the same manner as the second embodiment.

All concave shaped portions 27 in this embodiment have the same shape, and have curved surfaces (broadly-defined parabolic surface) obtained by changing an aspect ratio viewed from the light extracting direction of the rotary parabolic surface such as the concave shaped portion 27 in the second embodiment. An opening edge 29 of the concave shaped portion 27 having the parabolic surface is formed in an elliptical shape. As shown in FIG. 12B, a short axis of the elliptical shape of the opening edge 29 viewed from the light extracting direction is extended in the same direction as the axis line “L” of the light source 17 extending in the vertical direction. In other words, the opening edge 29 of the concave shaped portion 27 is formed in an elliptical shape flattened in the vertical direction and has the short axis extending in the vertical direction (y-direction) and a long axis extending in the horizontal direction (x-direction).

Since viewing the liquid crystal display from the vertical direction is rare as previously described, a narrow visual angle in the vertical direction is not problematic in practical use. However, since viewing the liquid crystal display from the horizontal direction is quite ordinary, the narrow visual angle in the horizontal direction is problematic in practical use. Thus, in the liquid crystal display, visual angular characteristics in the horizontal direction are important compared to the visual angular characteristics in the vertical direction. Therefore, in the light source device 11 used in the backlight device 12, it is preferable that the lights in the vertical direction are narrowed so as to be focused to the light extracting direction without extremely narrowing the lights in the horizontal direction.

In this embodiment, as described above, the opening edge 29 of the concave shaped portion 27 is formed in the elliptical shape, with the short axis made to coincide with the vertical direction (y-direction) and the long axis made to coincide with the horizontal direction (x-direction). Therefore, the light distribution in the horizontal direction (x-direction) can be broaden in spite of that the axis line is arranged in the posture extending in the vertical direction (y-direction). In addition, since the axis line “L” of the light source 17 is set in the posture extending in the vertical direction, necessary broadening of the light distribution in the vertical direction can be secured. Accordingly, by the structure of this embodiment, optical characteristics suitable for the visual angular characteristics required for the liquid crystal display can be achieved. Specifically, the liquid crystal display 14 using the light source device 11 of this embodiment in the backlight device 12 has a sufficiently broad view angle in the horizontal direction with securing the view angle in the vertical direction required for practical use.

It is apparent that the opening edge 29 of the concave shaped portion 27 formed in the elliptical shape as in this embodiment can achieve smaller difference between the light distribution in the 0°-direction (yz surface) and the light distribution in the 90°-direction (xz surface) by suitably setting a flatness ratio of the elliptical shape compared to the arrangement of FIG. 20 where the triangular protrusions are arranged on the reflection plate.

As is explained in detail for the first embodiment with reference to FIG. 6, when the opening edge 29 of the concave shaped portion 27 is formed in the circular shape, it is preferable that the radius “r” of the opening edge 29 of the concave shaped portion 27 is set to be larger than the outer radius “I” of the light source 17. For the same reason, when the opening edge 29 is formed in the elliptical shape like the concave shaped portion 27 in this embodiment, it is preferable that at least the long axis of the elliptical shape is set to be larger than the outer radius of the light source 17. In addition, it is further preferable that the short axis of the elliptical shape of the opening edge 29 is set to be larger than the outer radius of the light source 17.

Other structures and operations of the fourth embodiment are the same as those of the second embodiment, and therefore the same reference signs are assigned to the same elements and the explanations therefore are omitted.

### Fifth Embodiment

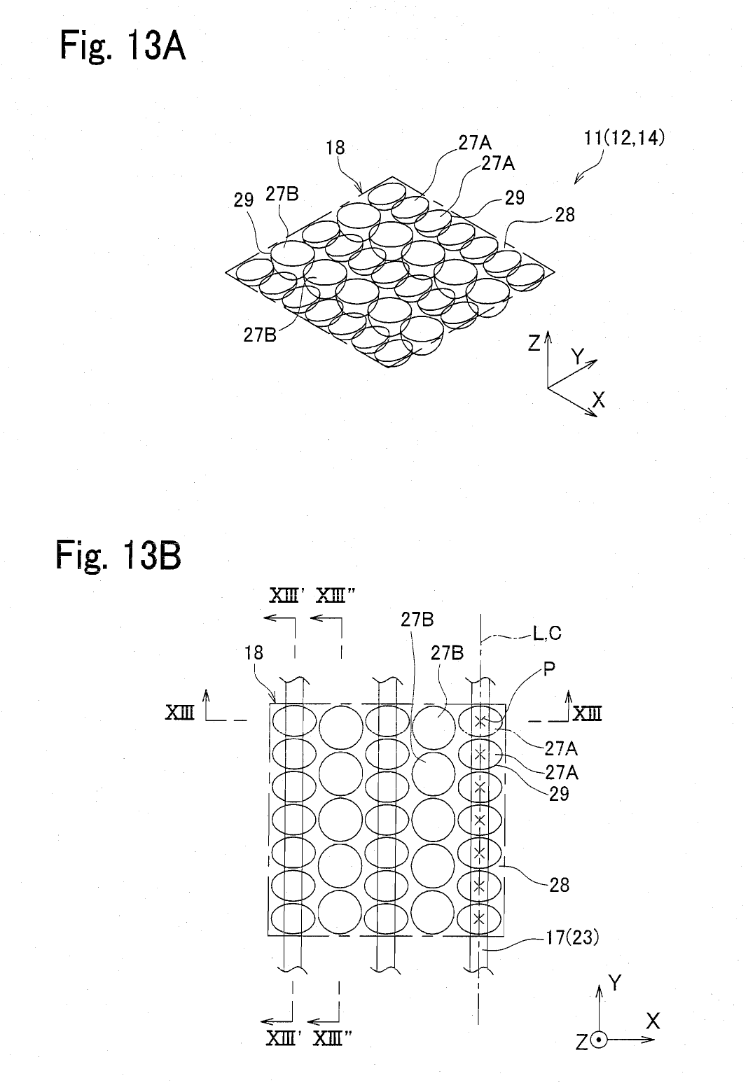

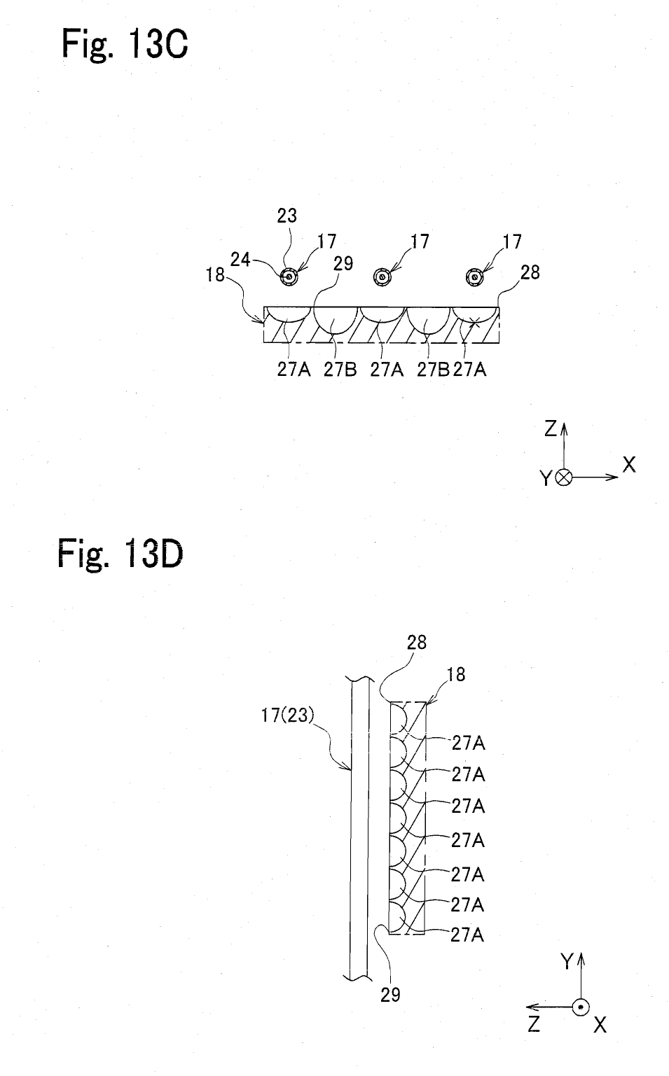

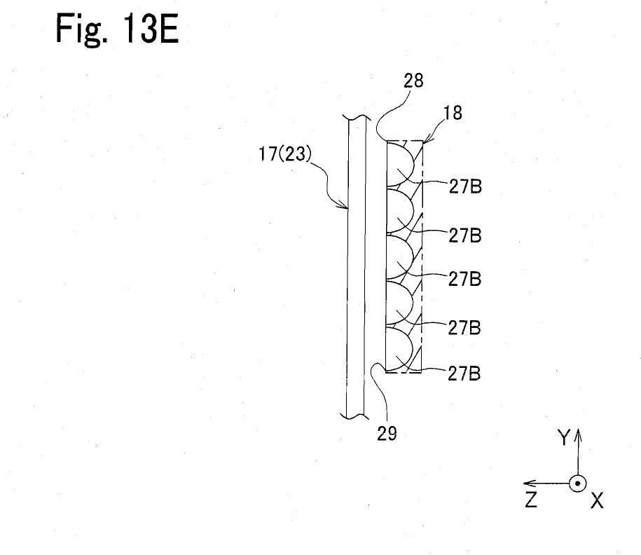

A light source device 11 of a fifth embodiment of the present invention shown in FIG. 13A to FIG. 13D has a reflection plate 18 in which not only concave shaped portions 27A are arranged along the axis line “L” of individual light sources 17 viewed from the light extracting direction but also concave shaped portions 27B are arranged between the mutually adjacent light sources 17.

In this embodiment, the shapes of the concave shaped portions 27A arranged along the axis line “L” of the light sources 17, and the shapes of the concave shaped portions 27B arranged between the light sources 17 are different from each other. Specifically, similarly to the fourth embodiment, each of the concave shaped portions 27A arranged along the axis line L of the light source 17 is a broadly-defined parabolic surface with an opening edge 29 formed in the elliptical shape. Meanwhile, each of concave shaped portions 27B arranged between the light sources 17 is formed in the rotary parabolic surface with the opening edge 29 formed in the circular shape. In addition, as most clearly shown in FIG. 13C, a depth “d” of the concave shaped portion 27B arranged between the light sources 17 is deeper than the depth “d” of the concave shaped portion 27A arranged along the axis line “L” of the light source 17.

If the reflection plate 18 merely had the flat portion 28 without the concave shaped portions 27A and 27B, a maximum luminance would be observed just above the light source 17, and a minimum luminance would observed between the light sources 17. Accordingly, in order to improve the luminance uniformity in the light extracting direction, it is preferable that the reflected light toward just above the light sources 17 from the reflection plate 18 is reduced relatively to the reflected light to portions between the light sources 17 from the reflection plate 18. Meanwhile, the shallow depth of the concave shaped portion causes broadened light distribution, the deep depth of the concave shaped portion causes the light distribution becomes higher in the 90°-direction (Z-direction). In this embodiment, as described above, the depth “d” of the concave shaped portion 27B arranged between the light sources 17 is deeper than the depth “d” of the concave shaped portion 27A arranged along the axis line “L” of the light source 17. Therefore, the light distribution of the reflected light from the concave shaped portion 27B between the light sources 17 is higher than in the 90°-direction (Z-direction) than the light distribution of the reflected light of the concave shaped portion 27A arranged along the axis line “L” of the light source 17. Reversely, the light distribution of the reflected light of the concave shaped portion 27A arranged along the axis line L of the light source 17 is more broadened than the light distribution of the reflected light of the concave shaped portion 27 between the light sources 17. Accordingly, the concave shaped portions 27A and 27B function to increase the reflected light to the light source 17 from the reflection plate 18, relatively to the reflected light toward just above the light source 17 from the reflection plate 18. In other words, the concave shaped portions 27A and 27B function to reduce the reflected light toward just above the light sources 17 from the reflection plate 18, relatively to the reflected light to between the light sources 17 from the reflection plate 18. As a result, the luminance uniformity in the light extracting direction is improved.

In the elliptical shape constituting the opening edge 29 of the concave shaped portion 27A arranged along the axis line “L” of the light source 17, the short axis coincides with the vertical direction (y-direction), and the long axis coincides with the horizontal direction (x-direction). Accordingly, although the light source 17 is arranged in the posture with the axis line extended in the vertical direction (y-direction), the light distribution can be broadened in the horizontal direction (x-direction).

Other structures and operations of the fifth embodiment are the same as those of the second embodiment, and therefore the same reference signs are assigned to the same elements and the explanations therefore are omitted.

### Sixth Embodiment

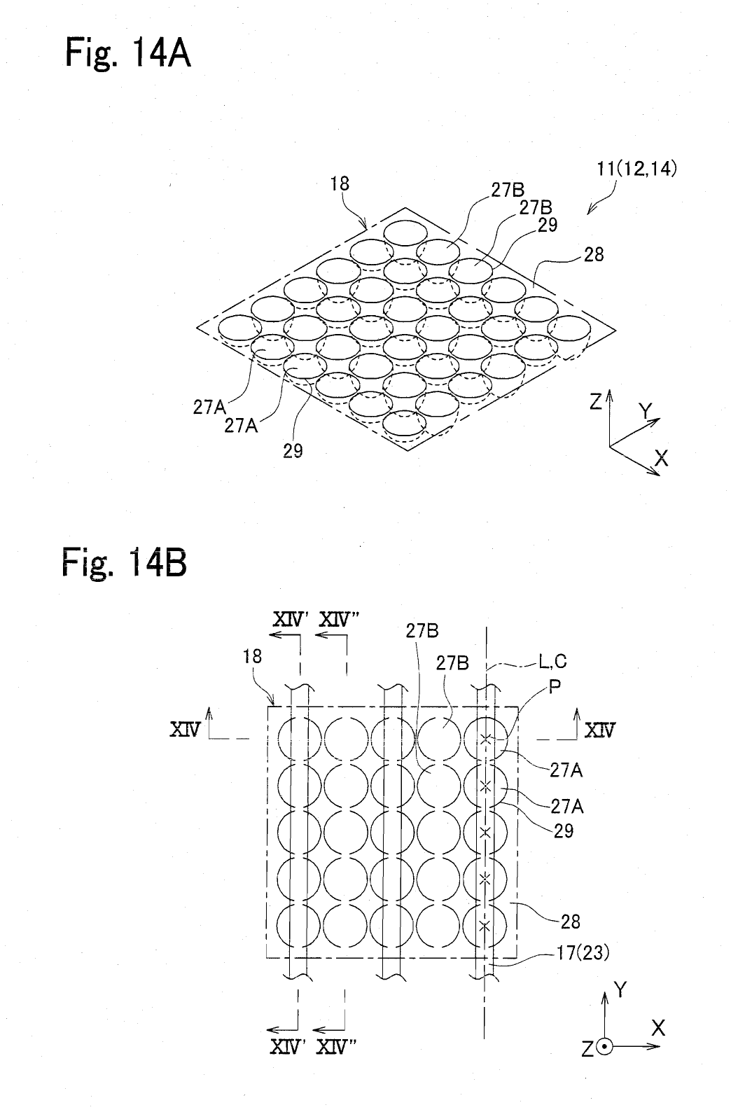

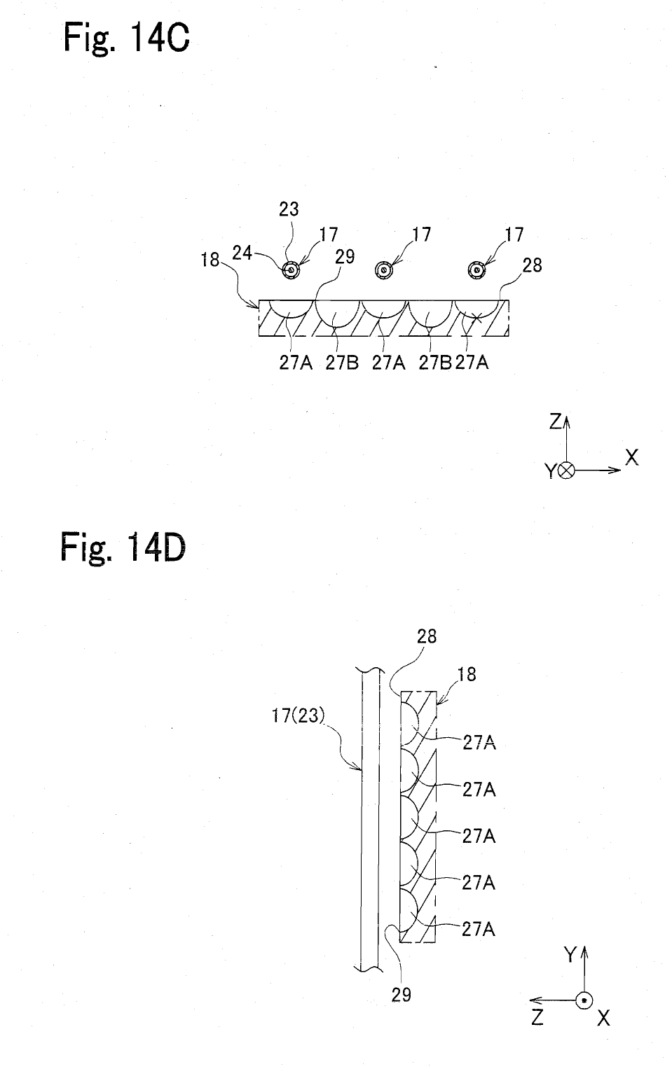

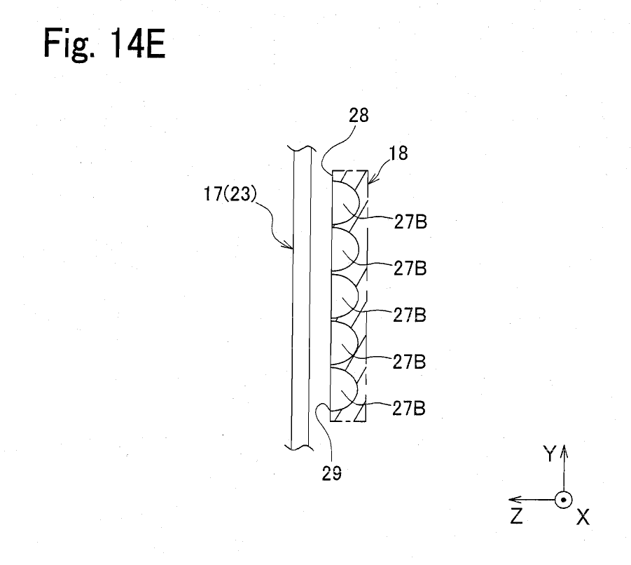

In a light source device 11 of the fifth embodiment of the present invention shown in FIG. 14A to FIG. 14D, both of concave shaped portions 27A arranged along the axis line “L” of a light source 17 and concave shaped portions 27B arranged between the light sources 17 are formed in rotary parabolic surfaces. Further, opening edges 29 of both of the concave shaped portions 27A and 27B are formed in circular shapes having the same radius. As clearly shown in FIG. 14C, a depth “d” of the concave shaped portion 27B arranged between the light sources 17 is deeper than the depth “d” of the concave shaped portion 27A arranged along the axis line “L” of the light source 17. Therefore, the reflected light to the portion between the light sources 17 from the concave shaped portion 27B can be increased relatively to the reflected light toward just above the light source 17 from the concave shaped portion 27A, thereby enabling to improve the luminance uniformity in the light extracting direction.

Other structures and operations of a sixth embodiment are the same as those of the second embodiment, and therefore the same reference signs are assigned to the same elements and the explanation therefore are omitted.

### Seventh Embodiment

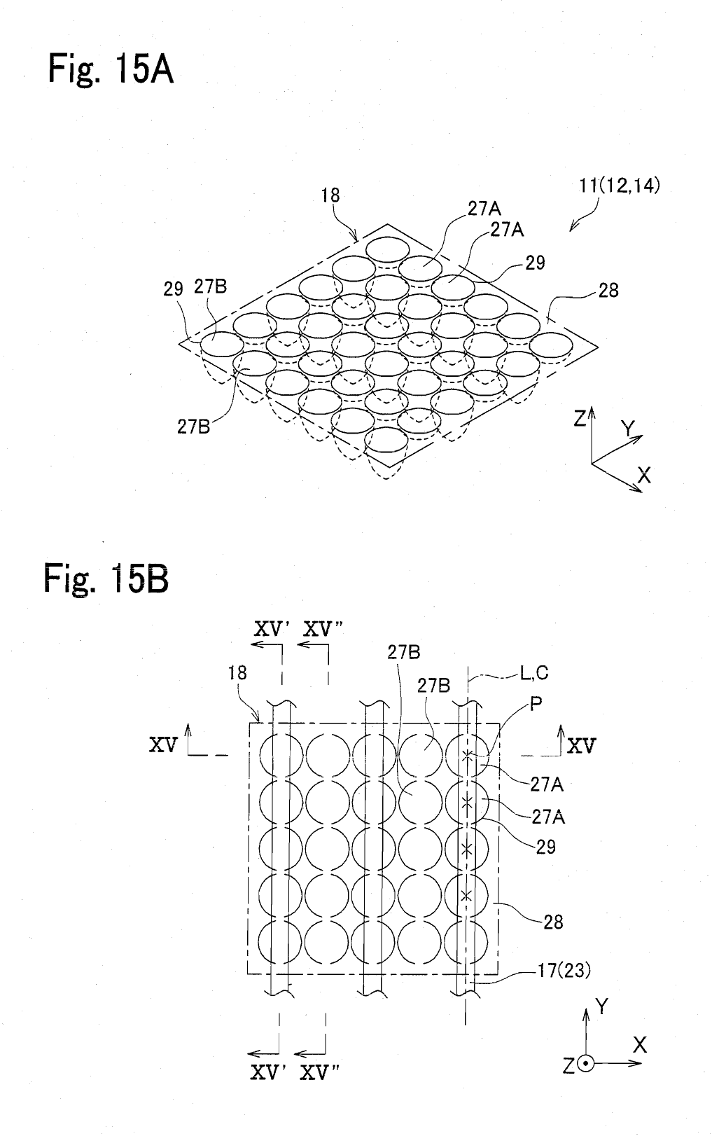

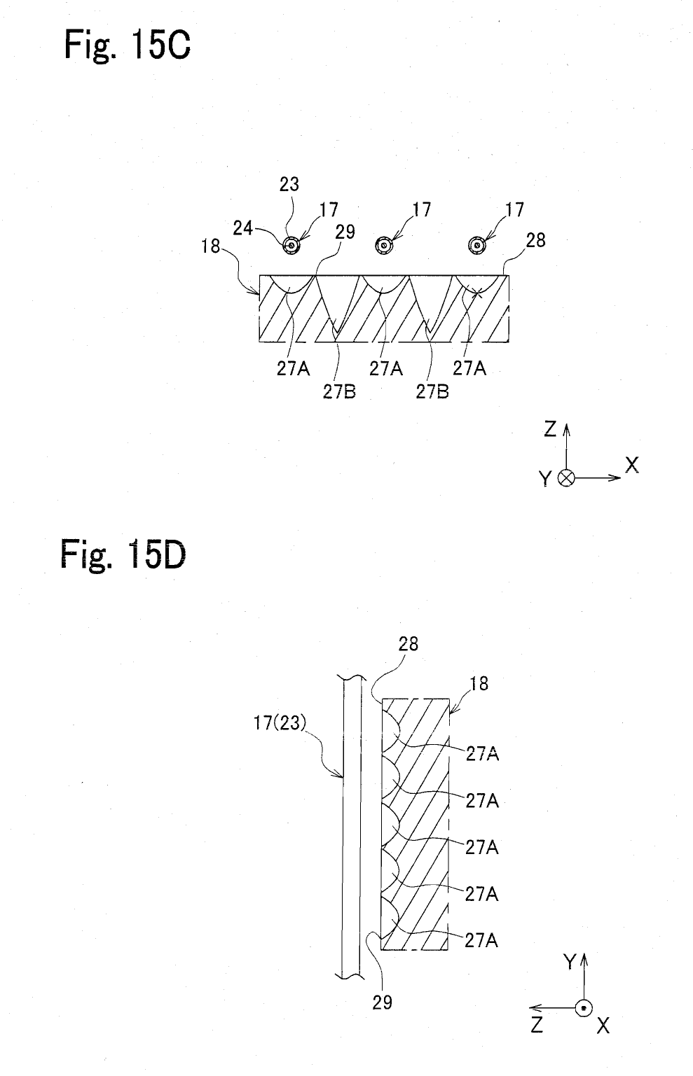

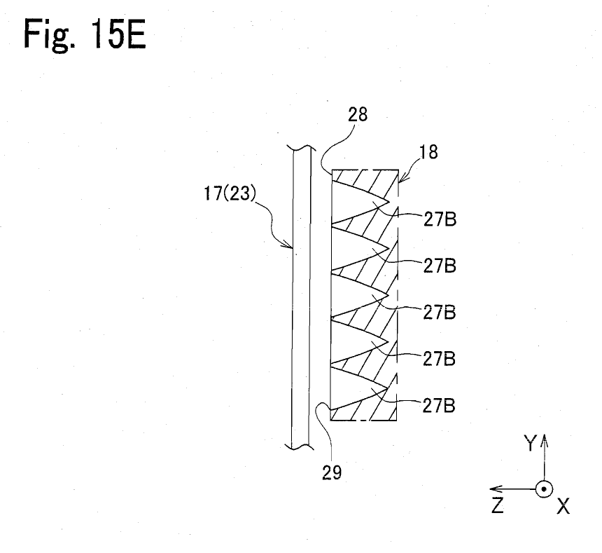

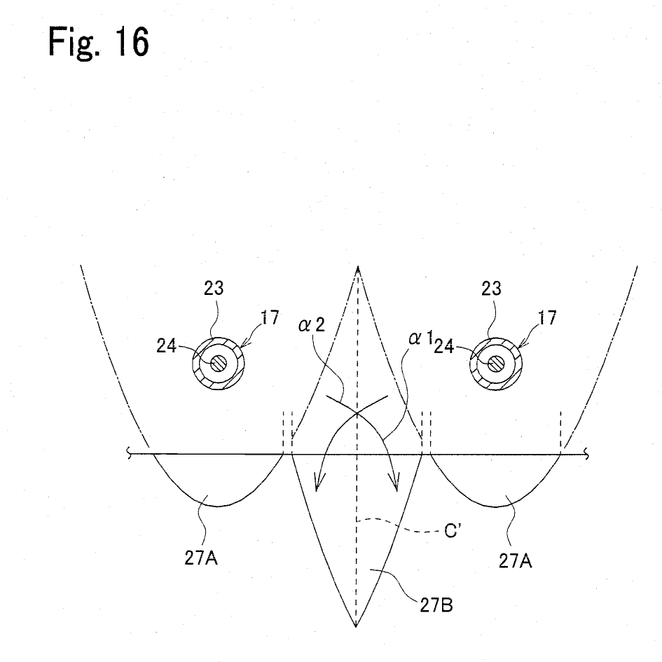

In a light source device 11 of the seventh embodiment of the present invention shown in FIGS. 15A to 15E, a concave shaped portion 27A arranged along an axis line “L” of a light source 17 is formed in a rotary parabolic surface with an opening edge 29 formed in the circular shape. Meanwhile, a concave shaped portion 27B arranged between the light sources 17 is not a conical surface, rotary parabolic surface (narrowly defined parabolic surface), and broadly-defined parabolic surface, but a rotating surface obtained based on a sectional shape of the concave shaped portion 27A by the following procedure. In FIG. 16, sectional shapes (parabola) of adjacent two concave shaped portions 27A in the adjacent xz sectional surface are extended in the light extracting direction. Next, as is schematically shown by arrows α1 and α2, portions of the extended sectional shape are moved with a center line C′ between the two concave shaped portions 27A set as a reference. Finally, the moved sectional shape is rotated around the center line C′, to obtain the rotating surface. Although the concave shaped portion 27B obtained by this procedure has a sharpened tip end, it may be formed in a hemispherical convex surface.

As is most clearly shown in FIG. 15C, the depth “d” of the concave shaped portion 27B arranged between the light sources 17 is deeper than the depth “d” of the concave shaped portion 27A arranged along the axis line “L” of the light source 17, thus making it possible to improve the luminance uniformity in the light extracting direction.

Other structure and operations of the seventh embodiment are the same as those of the second embodiment, and therefore the same reference signs are assigned to the same elements and the explanations therefore are omitted.

Explanation will be given herebelow for the element of the backlight device 12 other than the light source device 11, namely, the diffusion plate 19, the diffusion sheet 20, the lens sheet 21, and the luminance increasing film 22 (see FIGS. 1, 2, 7, and 10). Above a front side of the light sources 17 viewed from the light extracting direction, the diffusion plate 19, the diffusion sheet 20, the lens sheet 21, and the luminance increasing film 22 are arranged in this order from the side of the light source 17. The liquid crystal panel 13 is disposed on the luminance increasing film 22.

The diffusion plate 19 has a light incident surface 19a and a light outgoing surface 19b, so that the light emitted from the light source device 11 is guided from the light incident surface 19a to the light outgoing surface 19b and emitted to the liquid crystal panel 13 via other optical films 20 to 22. The diffusion plate 19 is a plate obtained by mixing a diffusing material such as silica in a resin such as methacrylstyrene (MS) which is acrylic resin, polycarbonate (PC), and Zeonor and has a thickness of approximately 1 to 3 mm. Instead of mixing the diffusing material in a plate, diffusion of lights can be achieved by forming unevenness on the surface of the diffusion plate. In this embodiment, an acrylic plate of 2 mm thickness in which silica is mixed is used. The diffusion plate 19 improves the luminance uniformity of the light outgoing surface 19b by diffusing a direct light from the light source 17 and the reflected light of the reflection plate 18.

The diffusion sheet 20 has a thickness of several tens μm to several hundreds μm, and similarly to the diffusion plate 19, the diffusing material such as silica is mixed in the resin such as amyl. The diffusion plate may have prisms formed on a surface thereof for correcting the lights. For achieving both of diffusion and correction of light at low cost, a paste containing a diffusion material and mixed with silica beads having diameter of several μm to several tens μm may be applied to the surface of the diffusion sheet 20. This embodiment uses the diffusion sheet of 150 μm whose surface is applied with the paste mixed with the silica beads. With the paste, lights diffused by the diffusion plate 19 are further diffused and the diffused lights are collected in a front side direction by the beads, thereby increasing a front luminance.

The lens sheet 21 has a thickness of several hundreds μm and is formed with convex and concave lenses on a surface thereof. The lens sheet used in this embodiment is provided with triangular shapes having height of 20 μm arranged from upside to downside at a pitch of 50 μm. The lens sheet 21 corrects the lights emitted sideward from the lengthy light sources arranged in parallel, thus further improving the front luminance.

The luminance increasing film 22 has a thickness of several hundreds μm and is constituted by several tens to several hundreds of laminated resin layers with different refractive index for transmitting P-waves and reflecting S-waves. In this embodiment, the luminance increasing film has 400 μm of thickness. The luminance increasing film 22 transmits only the P-waves included the lights collected by the lens sheet 21 and reflects the S-waves. Therefore, the S-waves absorbed by the liquid crystal panel 13 can be effectively used, thus improving both of the front luminance and luminance efficiency.

The present invention is not limited to the above-described embodiments and various modifications are possible.

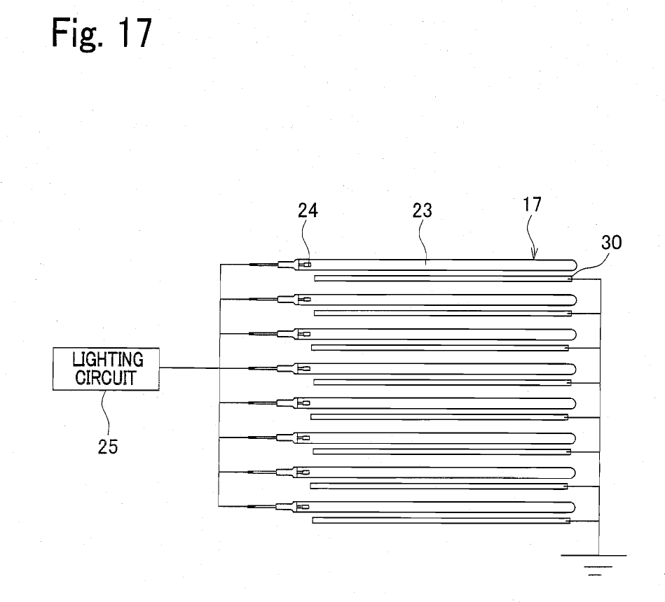

For example, although the reflection plate 18 serves also as the external electrode (see FIG. 3) in the embodiments, the external electrode may be provided as a separated element from the reflection plate 18. When this arrangement is adopted, external electrodes 30 separated from each other may be provided for respective light sources 17 as shown in FIG. 17.

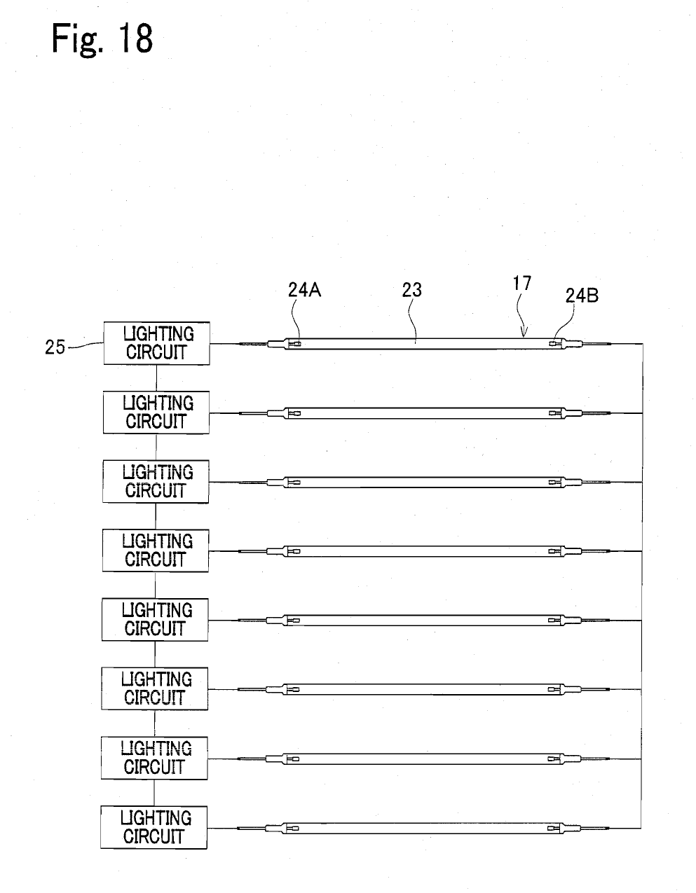

Further, as shown in FIG. 18, the light source 17 may be internal-internal electrode type which has a pair of internal electrodes 24A and 24B respectively provided at one of both ends of inside of the bulb 23. When such arrangement is adopted, the lighting circuit 17 may be provided for each of the light sources 17 as shown in FIG. 18. However, for reducing cost, one lighting circuit 25 can be provided for every two light sources 17.

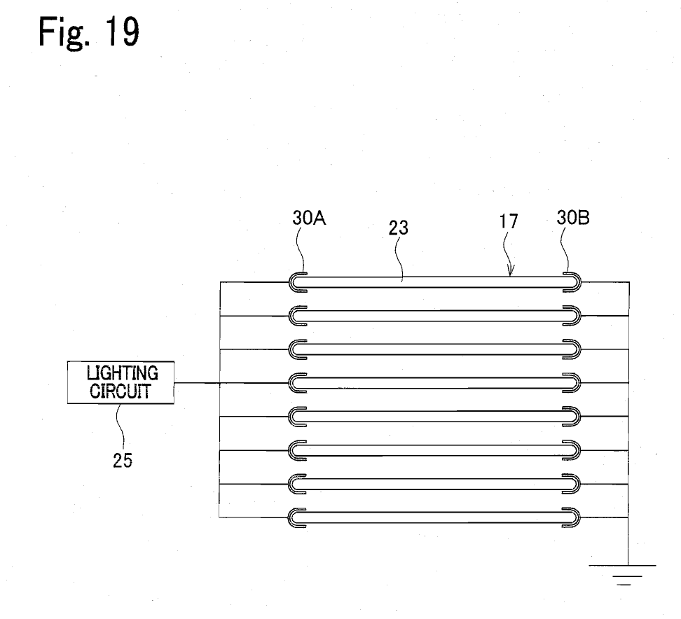

Further, as shown in FIG. 19, the light source 17 may be external-external electrode type which has a pair of external electrodes 30A and 30B respectively provided at one of both ends of outside of the bulb 23. In the external-external electrode type, discharge of the discharge medium is a dielectric barrier discharge. Therefore, each of light sources 17 can be lighted by providing at least one lighting circuit 25. The external electrodes 30A and 30B is required to be spaced from the discharge medium in the bulb 23 and therefore may be in contact with an outer periphery of the bulb 23.

### INDUSTRIAL APPLICABILITY

The present invention releases a restriction by the arrangement of the light source, and a restriction by the size of the liquid crystal display, namely, releases the restriction by the length of the a tube shaped light source, thus making it possible to improve efficiency and luminance uniformity, and therefore is useful as the light source device, etc, for the liquid crystal backlight.

The present invention overcomes restrictions due to a dispose arrangement of light sources as well as restrictions due to a size of a liquid crystal display, i.e., restrictions due to a length of a tube-shaped light source, thereby achieving efficiency and luminance uniformity. Therefore, the present invention is advantageous for applications such as a backlight for liquid crystal display

1. A light source device, comprising:
a plurality of tube-shaped light sources arranged at intervals so that axis lines thereof extend along the same direction; and
a reflection member arranged to backsides of the light sources viewed from a light extracting direction and having a flat portion opposed to the light sources and a plurality of concave shaped portions recessed from the flat portion in a direction away from the light sources, the concave shaped portions having circular or elliptical opening edges formed at connection portions with the flat portion and being arranged at least along each of the axis lines of the light sources viewed from the light extracting direction.

2. The light source device according to claim 1, wherein a radius of the circular shape or a long axis of the elliptical shape constituting the opening edge is larger than an outer radius of the light source.

3. The light source device according to claim 2, wherein each of the concave shaped portions has a conical or parabolic surface.

4. The light source device according to claim 3, wherein the axis line of each of the light sources and a center line formed by connecting positions spaced furthest from the axis line of the plurality of concave shaped portions arranged along the axis line substantially coincide with each other viewed from the light extracting direction.

5. The light source device according to claim 1, wherein the concave shaped portions are arranged at the flat portion between the light sources adjacent to each other viewed from the light extracting direction.

6. The light source device according to claim 5, wherein a depth of each of the concave shaped portions arranged between the light sources is deeper than the depth of each of the concave shaped portions arranged along the axis lines of the light sources.

7. The light source device according to claim 1, wherein the light sources are arranged in a posture where the axis line extends in a gravity direction.

8. The light source device according to claim 7, wherein the opening edges of the concave shaped portions arranged along the axis lines of the light sources have the optical shape with a short axis extending along the axis line viewed from the light extracting direction.

9. A backlight device, comprising:
the light source device according to claim 1; and
an optical member including at least a diffusion plate having a light incident surface and a light outgoing surface and guiding lights emitted from the light source device from the light incident surface to the light outgoing surface so as to emit the lights from the light outgoing surface.

10. A liquid crystal display, comprising:
the backlight device according to claim 9; and
a liquid crystal panel disposed so as to be opposed to the light outgoing surface of the diffusion plate.
